(19) United States
(12) Patent Application Publication
(10) Pub. No.: US 2026/0201250 A1
(43) Pub. Date: Jul. 16, 2026

(54) LIQUID CRYSTAL COMPOSITION AND LIQUID CRYSTAL DISPLAY DEVICE

(71) Applicant: Jiangsu Hecheng Display Technology Co., Ltd., Nanjing (CN)

(72) Inventors: Di HE, Nanjing (CN); Wenquan DING, Nanjing (CN); Yafei YANG, Nanjing (CN); Panpan WANG, Nanjing (CN); Huijuan DAI, Nanjing (CN); Lifang YAO, Nanjing (CN)

(73) Assignee: Jiangsu Hecheng Display Technology Co., Ltd., Nanjing (CN)

(21) Appl. No.: 19/135,135

(22) PCT Filed: Nov. 7, 2023
(86) PCT No.: PCT/CN2023/130203

§ 371 Date: Jun. 3, 2025

(30) Foreign Application Priority Data
Dec. 9, 2022 (CN) 202211583693.2

(51) Int. Cl. C09K 19/12; C09K 19/20; C09K 19/30; C09K 19/34

(52) U.S. Cl. CPC C09K 19/12; C09K 19/20; C09K 19/3003; C09K 19/3475; C09K 19/348; C09K 19/3491; C09K 2019/122; C09K 2019/124; C09K 2019/2035; C09K 2019/3004; C09K 2019/3009; C09K 2019/301

(57) ABSTRACT

The present invention provides a liquid crystal composition and a liquid crystal display device. The liquid crystal composition comprises at least one compound of general formula I and at least one compound of general formula II. Via designing the components of the liquid crystal composition, the liquid crystal composition prepared in the present invention has a larger Kₐᵥₑ value, a higher ε_{⊥} and a lower LC scattering, and has an appropriate optical anisotropy and clearing point at the same time, which makes the liquid crystal display device containing the same have a better transmission and contrast rate, and suitable for display elements of VA, IPS or FFS type.

### CROSS-REFERENCE TO RELATED APPLICATIONS

This application is the National Stage of International Application No. PCT/CN2023/130203, filed Nov. 7, 2023, which claims the benefit of Chinese Application No. 202211583693.2, filed Dec. 9, 2022, the contents of which is incorporated by reference herein.

### TECHNICAL FIELD

The present invention belongs to the technical field of liquid crystal display technology, specifically relates to a liquid crystal composition and a liquid crystal display device.

### BACKGROUND ARTS

Liquid crystal display elements can be used in all kinds of domestic electrical apparatuses, measuring apparatuses, automotive panels, word processors, computers, printers, televisions and so forth, such as clocks and calculators. According to the types of display mode, it can be classified into PC (phase change), TN (twisted nematic), STN (super twisted nematic), ECB (electrically controlled birefringence), OCB (optically compensated bend), IPS (in-plane switching), VA (vertical alignment) and so forth. According to the driving ways of elements, it can be classified into PM (passive matrix) type and AM (active matrix) type. PM is classified into the static type, multiplex type and so forth. AM is classified into TFT (thin film transistor) type, MIM (metal insulator metal) type and so forth. The types of TFT comprise amorphous silicon and polycrystal silicon. The latter is classified into a high-temperature type and a low-temperature type according to the manufacturing process. According to the types of light source, liquid crystal display elements can be classified into a reflection type utilizing a natural light, a transmission type utilizing a backlight, and a semi-transmission type utilizing both the natural light and the backlight.

The optical anisotropy of the liquid crystal composition is associated with the contrast rate of the element. A large optical anisotropy or a small optical anisotropy is needed with the variation of the display mode of the element (that is, an appropriate optical anisotropy is needed). The product (Δn×d) of the optical anisotropy (Δn) of the composition and the cell gap (d) is designed to maximize the contrast rate. An appropriate value of the product depends on the type of the work mode, and for an element with a small cell gap, liquid crystal composition having a large optical anisotropy is preferred.

The contrast rate is the rate between the brightest area and the darkest area of an image. The larger the rate, the more the gradations from black to white, and thereby the color performance is much more enriched. The impact of contrast rate on the visual effect is very critical. Generally speaking, the larger the contrast rate, the clearer and more eye-catching the image, and the more vibrant and gorgeous the colors; and a small contrast rate makes the whole picture become gray and dull. High contrast rate is of a great help for image clarity, detail performance, gray level performance. With a high contrast rate, the image effect is better, and the colors are more saturated, otherwise, with a low contrast rate, the picture is indistinct, and the color is less vibrant.

A liquid crystal display element having a liquid crystal composition with a large absolute value of the dielectric anisotropy reduces the base voltage value, reduces the driving voltage and further reduces electric power consumption.

A liquid crystal display element having a liquid crystal composition with a lower threshold voltage reduces display power dissipation effectively, in particular, in consumables (for example, portable electronic products such as mobile phones, tablet computers and the like), a longer battery life would be achieved. However, for liquid crystal compositions with lower threshold voltages (which typically include groups with large dielectric polarity), the degree of order of the liquid crystal molecules is low, the Kₐᵥₑ value reflecting degree of order of the liquid crystal molecules reduces as well, and the light leakage and the contrast rate of the liquid crystal material are affected, these two are commonly difficult to balance.

Based on the light leakage performance test of traditional IPS-LCD, it is found by the person skilled in the art that the main causes of the light leakage issues of liquid crystal display device are as follows: LC scattering, rubbing uniformity, CF/TFT scattering, and polarize ability, wherein, LC scattering accounts for 63% of the factors affecting light leakage performance.

According to the following equation:

$$LC scattering ∝ \frac{d \cdot Δ {n}^{2} \cdot {( {n}_{e} + {n}_{o} )}^{2}}{{K}_{ave}} ,$$

wherein, d represents the cell gap of the liquid crystal cell, nₑ represents the refractive index of extraordinary light, nₒ represents the refractive index of ordinary light.

In order to increase the LC scattering of the liquid crystal materials, increasing average elastic constant Kₐᵥₑ (wherein, Kₐᵥₑ=(K₁₁+K₂₂+K₃₃)/3) is needed to improve the LC scattering. In the situation of increasing the Kₐᵥₑ, the light leakage of the liquid crystal material can be decreased.

In addition, the relationship between the contrast rate (CR) and the luminance (L) is as follows:

$$CR = {L}_{255} / {L}_{0} \times 100 \% ;$$

wherein, L₂₅₅ is the on-state luminance, and L₀ is the off-state luminance. It can be seen that CR is significantly affected by the change of L₀. In the off state, L₀ has nothing to do with the dielectric performance of the liquid crystal molecule, but is related to the LC scattering of the liquid crystal material itself. The smaller the LC scattering, the smaller the L₀, and the CR is thereby significantly increased.

It can be seen from the contrast-scattering formula

$$\frac{d \cdot Δ {n}^{2} \cdot {( {n}_{e} + {n}_{o} )}^{2}}{{K}_{ave}}$$

that, in order to realize an extremely high contrast rate, other than increasing Kₐᵥₑ value (K value), reducing Δn as much as possible is needed as well. Then with Δn reduced, the transmission is partially lost. In order to offset the loss in the transmission, increasing the ε_{⊥} (the dielectric constant perpendicular to the molecular axis) and K value to increase the transmission. Commonly, monomers with large K value have large Δn. Therefore, how to provide a liquid crystal composition having a larger K value and a smaller Δn both and having a higher transmission has become an urgent technical problem to be solved at present.

### SUMMARY OF THE INVENTION

Regarding the disadvantages in the prior art, it is an object of the present invention to provide a liquid crystal composition and a liquid crystal display device. Via designing the components of the liquid crystal composition, the liquid crystal composition prepared in the present invention has a larger Kₐᵥₑ value, a higher ε_{⊥} and a lower LC scattering, and has an appropriate optical anisotropy and clearing point at the same time, which is suitable for display elements of VA, IPS or FFS type.

To realize this object, the present invention adopts the following technical solutions:

In a first aspect, the present application provides a liquid crystal composition comprising at least one compound of general formula I and at least one compound of general formula II:

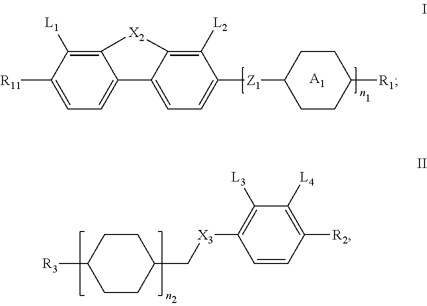

wherein, R₁ represents any one of C₁₋₁₂ (for example, it can be C₁, C₂, C₃, C₄, C₅, C₆, C₇, C₈, C₉, C₁₀, C₁₁ or C₁₂) halogenated or unhalogenated linear alkyl, C₃₋₁₂ (for example, it can be C₃, C₄, C₅, C₆, C₇, C₈, C₉, C₁₀, C₁₁ or C₁₂) halogenated or unhalogenated branched alkyl,

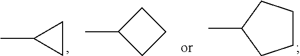

wherein, one or at least two nonadjacent —CH₂— group in the C₁₋₁₂ halogenated or unhalogenated linear alkyl and C₃₋₁₂ halogenated or unhalogenated branched alkyl can each be independently replaced by —CH═CH—, —C≡C—, —O—, —CO—, —CO—O— or —O—CO— group;
R₁₁ represents

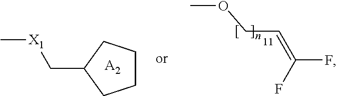

X₁ represents —O— or —S—, n₁₁ represents 0, 1, 2, 3 or 4;
ring

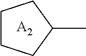

represents

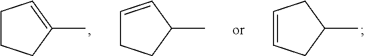

R₂ and R₃ each independently represents any one of C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

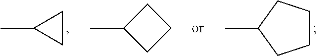

wherein, one or at least two nonadjacent —CH₂— group in the C₁₋₁₂ linear alkyl and C₃₋₁₂ branched alkyl can each be independently replaced by —CH═CH—, —C≡C—, —O—, —CO—, —CO—O— or —O—CO— group;
ring

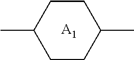

represents

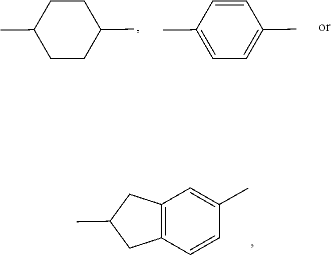

wherein, one or at least two —CH₂— in

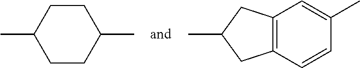

can each be independently replaced by —O—, one or at least two single bond in the rings can each be independently replaced by double bond; one or at least two —H on

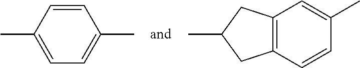

can each be independently replaced by —F, —Cl, —CN, —CH₃ or —OCH₃, one or at least two —CH═ in the rings can each be independently replaced by —N═;
L₁-L₄ each independently represents halogen atom;
X₂ represents —O— or —S—; X₃ represents —O— or —CH₂—;
Z₁ represents single bond, —CO—O—, —O—CO—, —CH₂O—, —OCH₂—, —CH═CH—, —C≡C—, —CH₂CH₂—, —CF₂CF₂—, —(CH₂)₄—, —CF₂O— or —OCF₂—;
n₁ represents 0, 1 or 2, when n₁ represents 2, ring

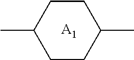

can be the same or different, Z₁ can be the same or different; and
n₂ represents 1 or 2.

In the present invention, via designing the components of the liquid crystal composition, the prepared liquid crystal composition has a larger Kₐᵥₑ value, a higher ε_{⊥} and a lower LC scattering, and has an appropriate optical anisotropy and clearing point at the same time, which is suitable for display elements of VA, IPS or FFS type.

The halogen atom includes fluorine atom, chlorine atom, bromine atom and iodine atom (the same below).

The followings are preferred technical solutions of the present invention, but not used as limitations of the technical solutions provided in the present invention. The objections and beneficial effects of the present invention can be better achieved and realized via the following preferred technical solutions.

In some embodiments of the present invention, the compound of general formula I is any one or the combination of at least two of the compounds with the following structures:

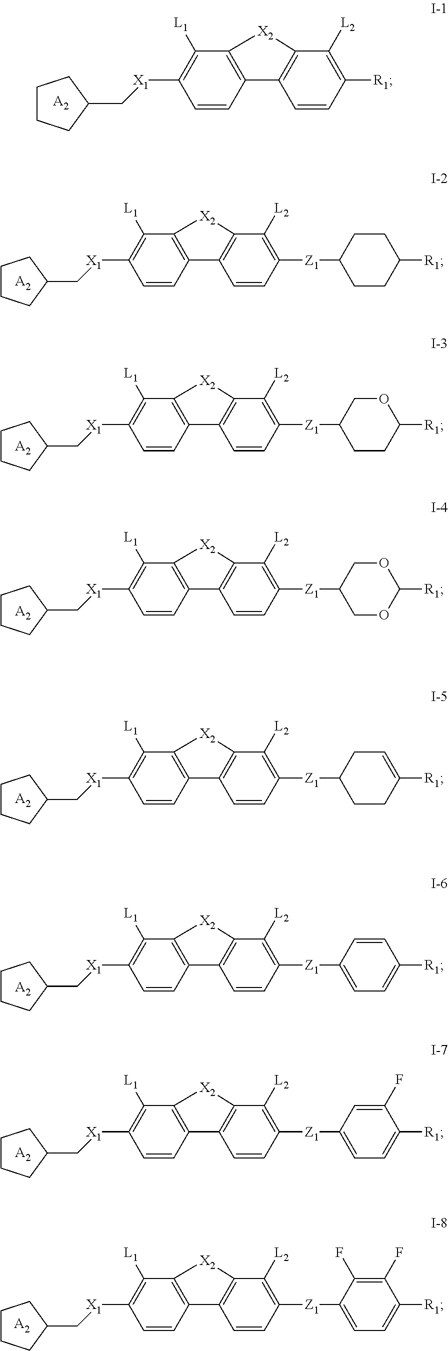

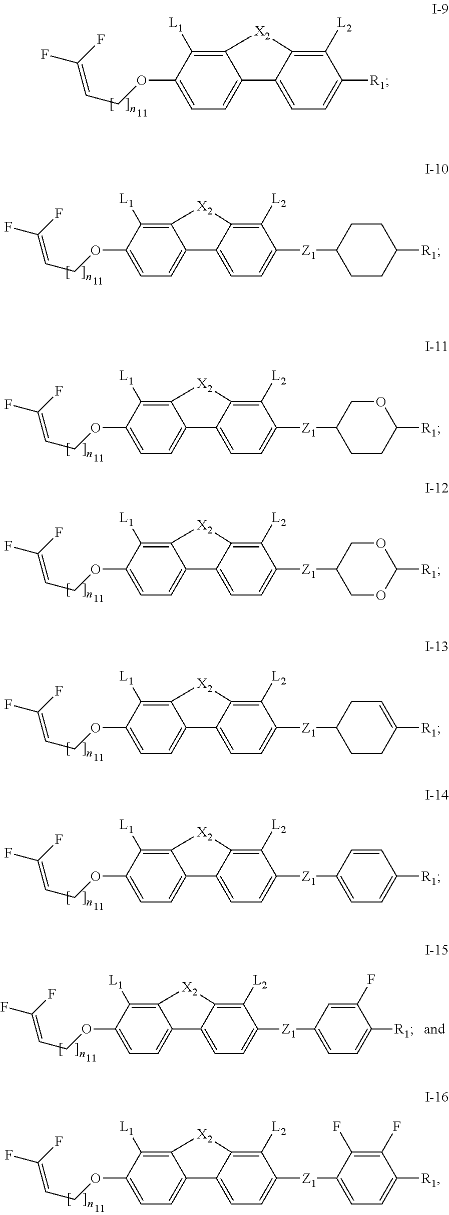

wherein, ring

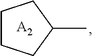

X₁, X₂, L₁, L₂, Z₁ and n₁₁ have the same protection scopes as aforesaid.

In some embodiments of the present invention, ring

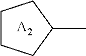

represents

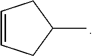

In some embodiments of the present invention, L₁ and L₂ both represent fluorine atom.

In some embodiments of the present invention, the compound of general formula I is the compound of general formula I-1 or the compound of general formula I-9.

In some embodiments of the present invention, the liquid crystal composition comprises at least two of the compound with the general formula I-1 and/or the compound of general formula I-9.

In some embodiments of the present invention, in the liquid crystal composition, percentage by weight of the compound of general formula I is 0.1%~35%, for example, it can be 0.1%, 0.2%, 0.5%, 1%, 2%, 4%, 6%, 8%, 10%, 12%, 14%, 16%, 18%, 20%, 22%, 25%, 26%, 28%, 30%, 32%, 35% or the like, further preferably, 2%~25%.

In some embodiments of the present invention, it is preferred to adjust the content of the compound of general formula I, such that the liquid crystal composition comprising the same has an appropriate optical anisotropy, an appropriate clearing point, a higher &1, a larger Kₐᵥₑ value and a smaller LC scattering.

In some embodiments of the present invention, the compound of general formula II is any one or the combination of at least two of the compounds with the following structures:

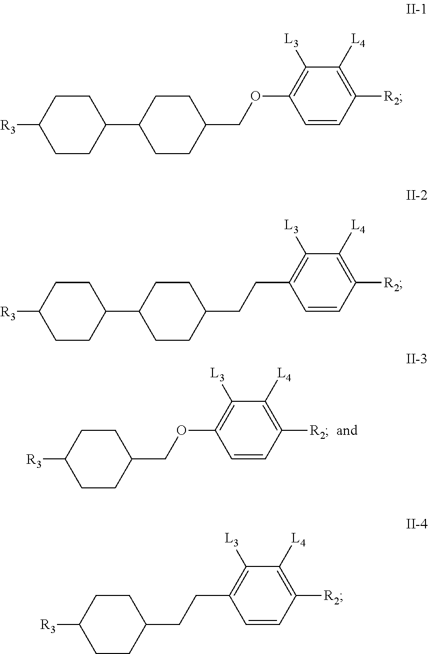

In some embodiments of the present invention, L₃ and L₄ both represent fluorine atom.

In some embodiments of the present invention, the compound of general formula II comprises the compound of general formula II-2 and/or the compound of general formula II-4.

In some embodiments of the present invention, the liquid crystal composition comprises at least two (for example, it can be two, three, four or five) compounds of general formula II.

In some embodiments of the present invention, the compound of general formula II comprises at least one compound selected from a group consisting of the compound of general formula II-1 and general formula II-3 and at least one compound selected from a group consisting of the compounds of general formula II-2 and general formula II-4.

In some embodiments of the present invention, in the liquid crystal composition, percentage by weight of the compound of general formula II is 0.1%~60%, for example, it can be 0.1%, 0.2%, 0.5%, 1%, 2%, 4%, 6%, 8%, 10%, 15%, 20%, 25%, 30%, 35%, 40%, 45%, 50%, 55%, 60% or the like, further preferably, 8%~60%.

In some embodiments of the present invention, it is preferred to adjust the content of the compound of general formula II such that the liquid crystal composition comprising the same has an appropriate optical anisotropy, an appropriate clearing point, a higher ε_{⊥}, a larger Kₐᵥₑ value and a smaller LC scattering.

In some embodiments of the present invention, the liquid crystal composition further comprises at least one compound of general formula N:

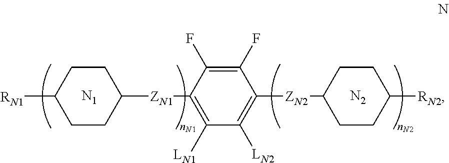

wherein, R_{N1} and R_{N2} each independently represents C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

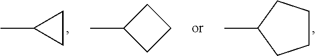

wherein, one or any more than two nonadjacent —CH₂— in the C₁₋₁₂ linear alkyl and C₃₋₁₂ branched alkyl can each be independently replaced by —CH═CH—, —C≡C—, —O—, —CO—, —CO—O— or —O—CO—;
ring

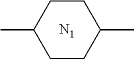

and ring

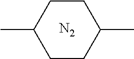

each independently represents

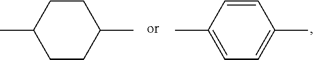

wherein one or at least two —CH₂— in

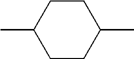

can be replaced by —O—, one or at least two single bond in the rings can be replaced by double bond; one or at least two —H on

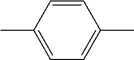

can each be independently replaced by —F, —Cl or —CN, one or at least two —CH═ in the rings can be replaced by —N═;
Z_{N1} and Z_{N2} each independently represents single bond, —CO—O—, —O—CO—, —CH═CH—, —C≡C—, —CF₂CF₂—, —(CH₂)₄—, —CF₂O— or —OCF₂—;
L_{N1} and L_{N2} each independently represents —H, C₁₋₃ (for example, it can be C₁, C₂ or C₃) alkyl, or halogen atom; and
n_{N1} represents 0, 1, 2 or 3, n_{N2} represents 0 or 1, and 0≤n_{N1}+n_{N2}≤3, wherein, when n_{N1} represents 2 or 3, ring

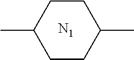

can be the same or different, Z_{N1} can be the same or different.

In some embodiments of the present invention, the compound of general formula Nis any one or the combination of at least two of the compounds with the following structures:

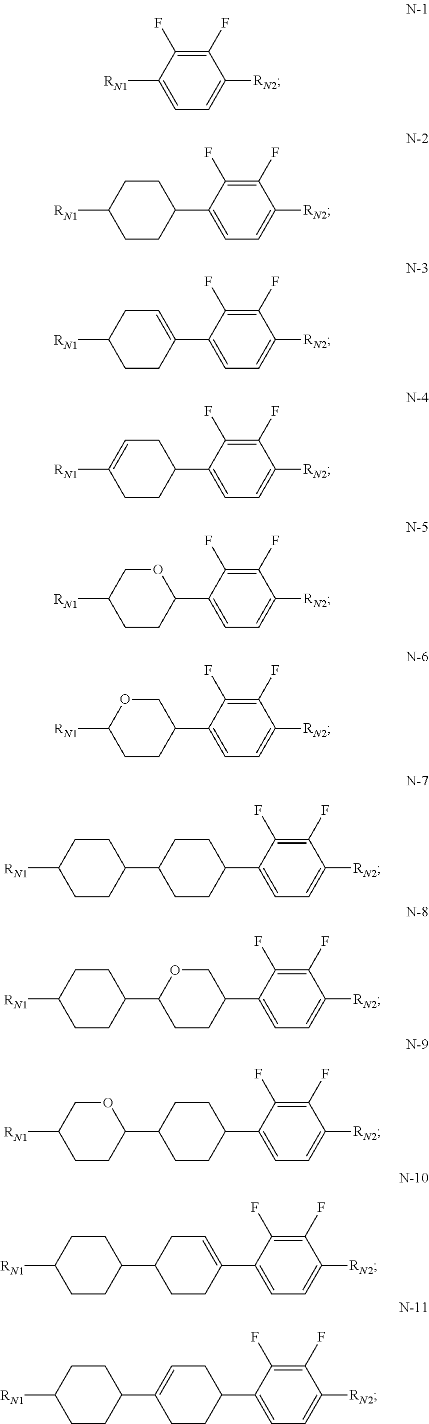

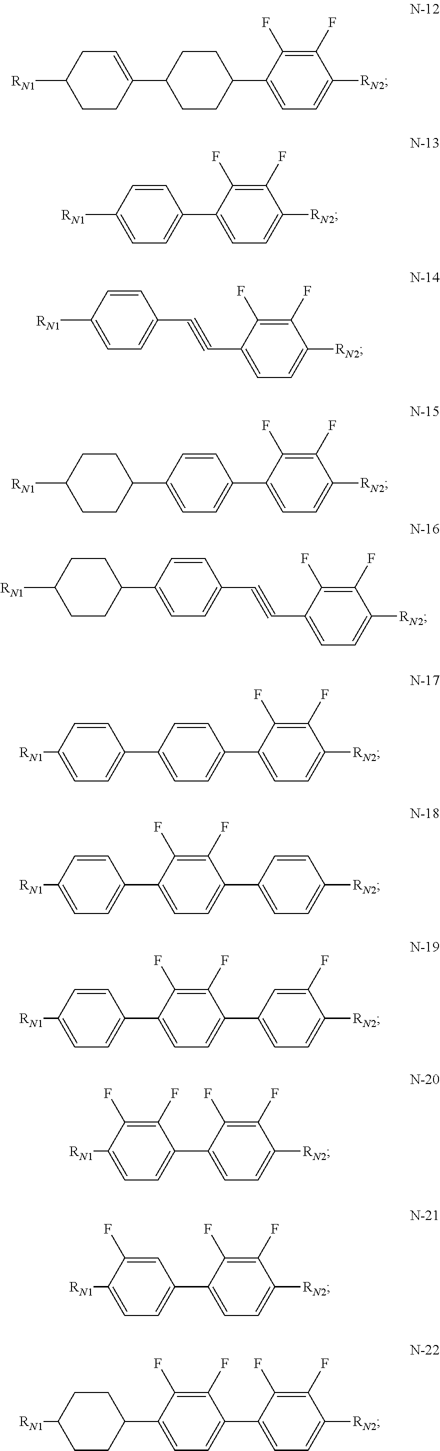

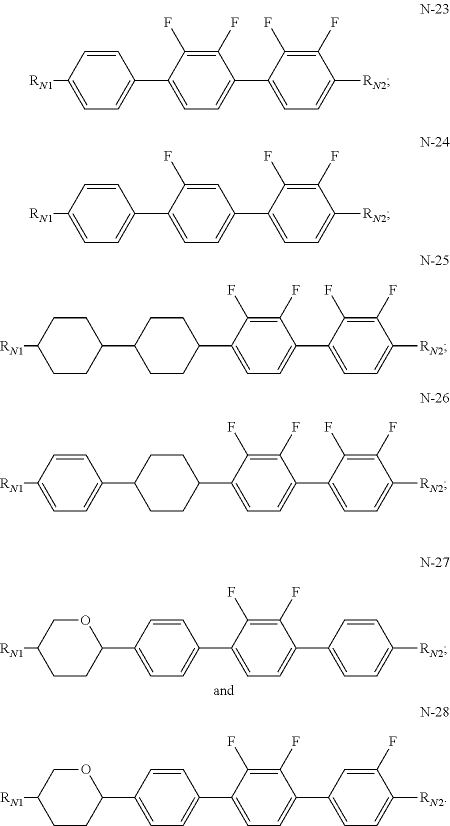

In some embodiments of the present invention, the compound of general formula N is selected from a group consisting of the compound of general formula N-2, the compound of general formula N-3, the compound of general formula N-7, the compound of general formula N-10, the compound of general formula N-13, the compound of general formula N-15, and the compound of general formula N-17.

In some embodiments of the present invention, in the liquid crystal composition, percentage by weight of the compound of general formula Nis 0.1%~50%, for example, it can be 0.1%, 0.2%, 0.5%, 1%, 2%, 4%, 6%, 8%, 10%, 15%, 20%, 25%, 30%, 35%, 40%, 45%, 50% or the like, further preferably, 2%~45%.

In some embodiments of the present invention, it is preferred to adjust the content of the compound of general formula N such that the liquid crystal composition comprising the same has an appropriate optical anisotropy, an appropriate clearing point, a higher ε_{⊥}, a larger Kₐᵥₑ value and a smaller LC scattering.

In some embodiments of the present invention, the liquid crystal composition further comprises at least one compound of general formula M:

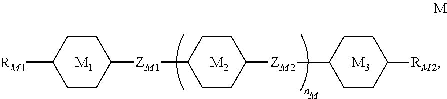

wherein, R_{M1} and R_{M2} each independently represents C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

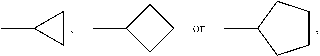

wherein, one or at least two nonadjacent —CH₂— in the C₁₋₁₂ linear alkyl or C₃₋₁₂ branched alkyl can each be independently replaced by —CH═CH—, —C≡C—, —O—, —CO—, —CO—O— or —O—CO—;
ring

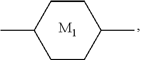

ring

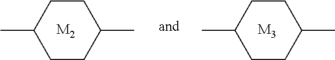

each independently represents

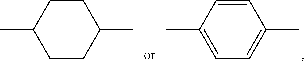

wherein, one or at least two —CH₂— in

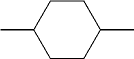

can be replaced by —O—, one or at least two single bond in the rings can be replaced by double bond; at most one —H on

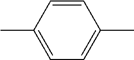

can be replaced by halogen atom;
Z_{M1} and Z_{M2} each independently represents single bond, —CO—O—, —O—CO—, —CH₂O—, —OCH₂—, —C≡C—, —CH═CH—, —CH₂CH₂— or —(CH₂)₄—; and
n_{M} represents 0, 1 or 2, wherein, when n_{M} represents 2, ring

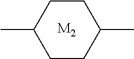

can be the same or different, Z_{M2} can be the same or different.

In some embodiments of the present invention, the compound of general formula Mis any one or the combination of at least two of the compounds with the following structures:

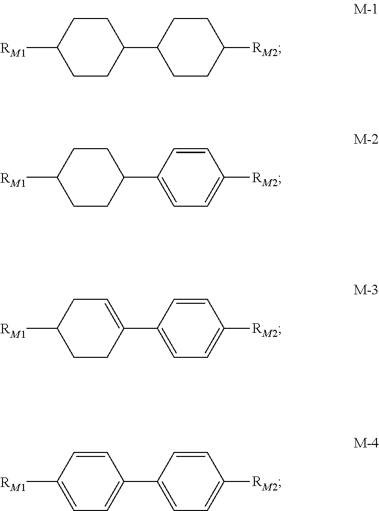

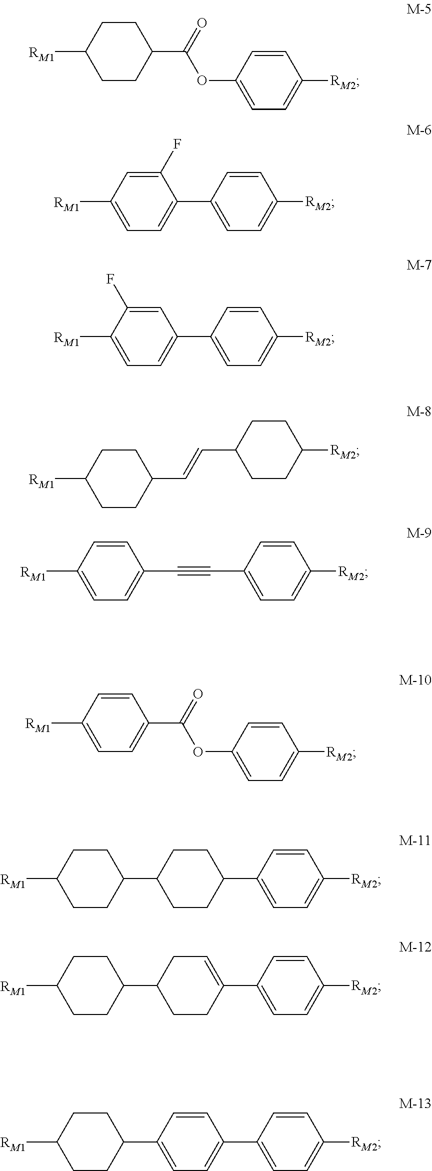

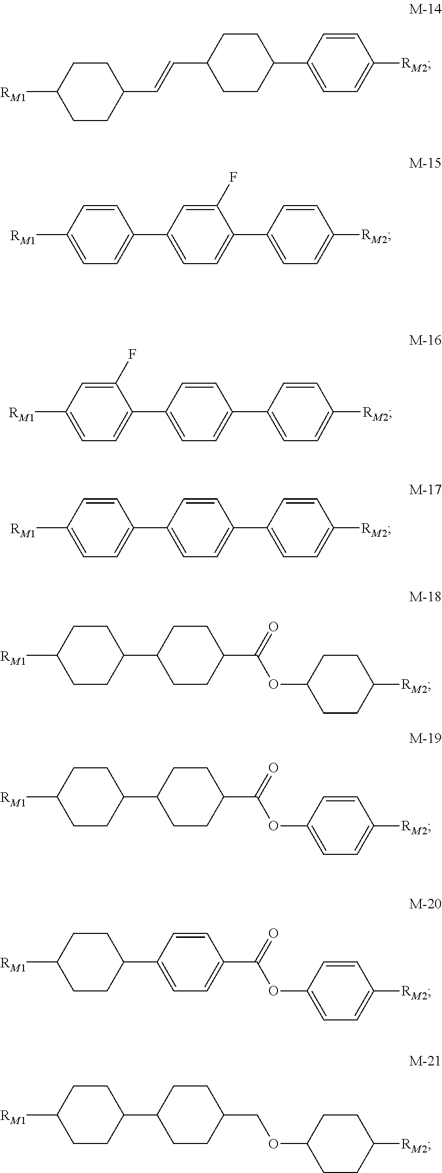

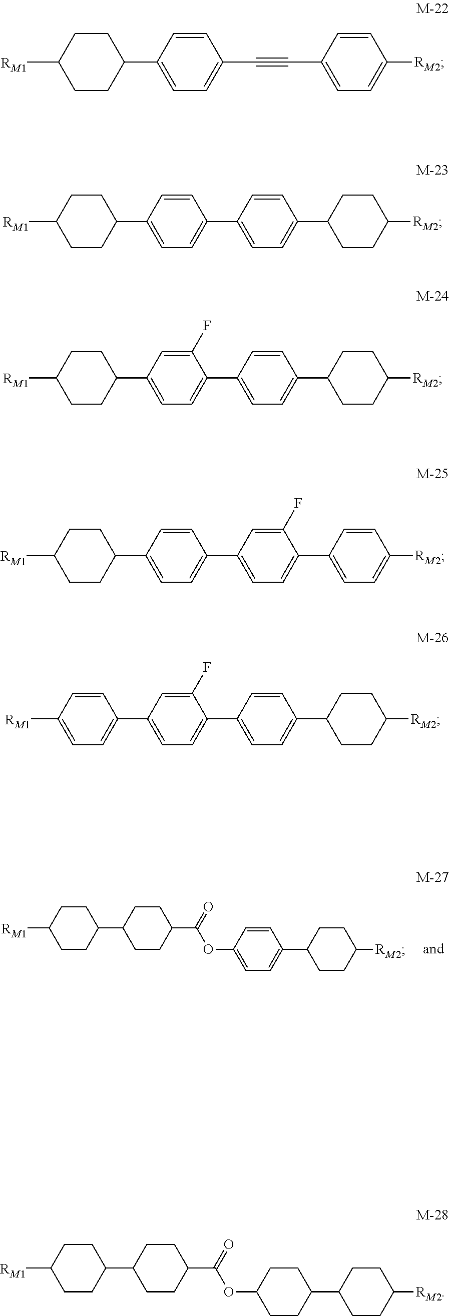

In some embodiments of the present invention, the compound of general formula M is selected from a group consisting of the compound of general formula M-1, the compound of general formula M-2, the compound of general formula M-4, the compound of general formula M-11, the compound of general formula M-13, the compound of general formula M-21, the compound of general formula M-23, the compound of general formula M-24, and the compound of general formula M-27.

In some embodiments of the present invention, in the liquid crystal composition, percentage by weight of the compound of general formula M is 0.1%-60%, for example, it can be 0.1%, 0.2%, 0.5%, 1%, 2%, 4%, 6%, 8%, 10%, 15%, 20%, 25%, 30%, 35%, 40%, 45%, 50%, 55%, 60% or the like, further preferably, 30%-50%.

In some embodiments of the present invention, the liquid crystal composition further comprises at least one compound of general formula B:

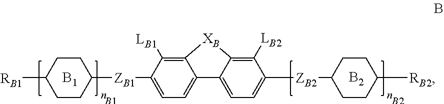

wherein, R_{B1} and R_{B2} each independently represents halogen atom, —CF₃, —OCF₃, C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

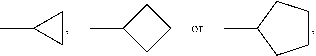

wherein one or at least two nonadjacent —CH₂— in the C₁₋₁₂ linear alkyl, C₃₋₁₂ branched alkyl,

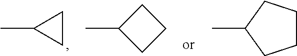

can each be independently replaced by —O—, —CO—, —CO—O— or —O—CO—; one or at least two nonadjacent —CH₂— in the C₁₋₁₂ linear alkyl, C₃₋₁₂ branched alkyl,

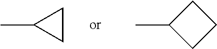

can each be independently replaced by —CH═CH— or —C≡C—;
ring

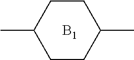

and ring

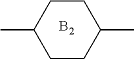

each independently represents

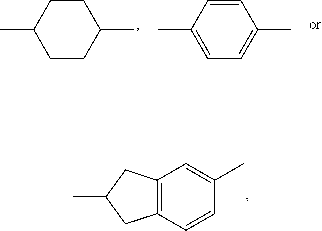

wherein one or at least two nonadjacent —CH₂— in

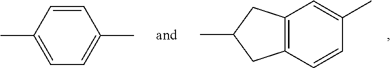

can be replaced by —O—, one or at least two single bond in the rings can be replaced by double bond; one or at least two —H on

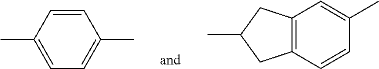

can each be independently replaced by —CN, —F or —Cl, one or at least two —CH═ in the rings can be replaced by —N═;
X_{B} represents —O—, —S— or —CO—;
L_{B1} and L_{B2} each independently represents —H, —F, —Cl, —CF₃ or —OCF₃;
Z_{B1} and Z_{B2} each independently represents single bond, —O—, —CO—O—, —O—CO—, —CH₂O—, —OCH₂—, —CH═CH—, —C≡C—, —CH₂CH₂—, —CF₂CF₂—, —(CH₂)₄—, —CF₂O— or —OCF₂—;
n_{B1} and n_{B2} each independently represents 0, 1 or 2, wherein when n_{B1} represents 2, ring

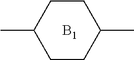

can be the same or different, when n_{B2} represents 2, ring

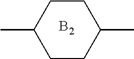

can be the same or different, Z_{B2} can be the same or different.

In some embodiments of the present invention, the compound of general formula B is any one or the combination of at least two of the compounds with the following structures:

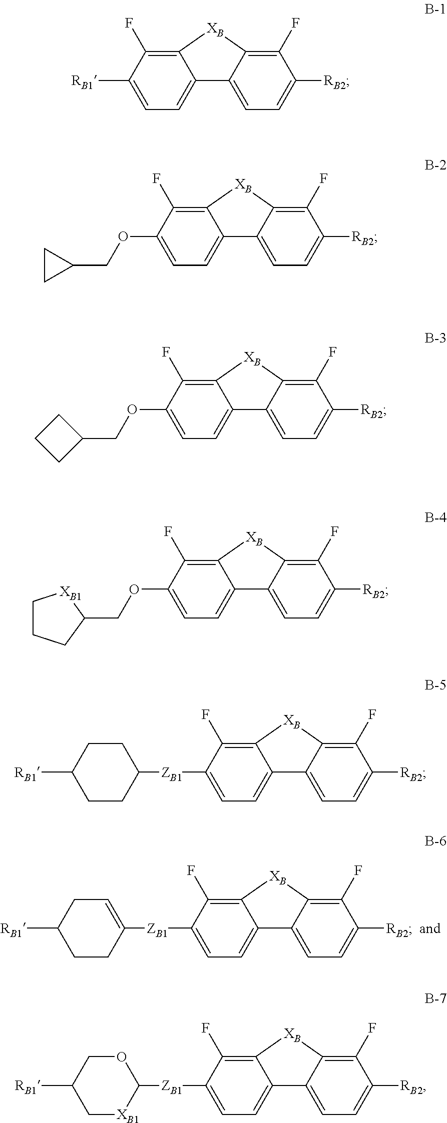

wherein, R_{B1}′ represents halogen atom, —CF₃, —OCF₃, C₁₋₈ (for example, it can be C₁, C₂, C₃, C₄, C₅, C₆, C₇ or C₈) liner alkyl, C₃₋₈ (for example, it can be C₃, C₄, C₅, C₆, C₇ or C₈) branched alkyl, C₁₋₈ (for example, it can be C₁, C₂, C₃, C₄, C₅, C₆, C₇ or C₈)alkoxy, C₂₋₈ (for example, it can be C₂, C₃, C₄, C₅, C₆, C₇ or C₈)alkenyl;
X_{B1} represents —O— or —CH₂—;
R_{B2}, X_{B} and Z_{B1} have the same protection scopes as aforesaid.

In some embodiments of the present invention, in the liquid crystal composition, percentage by weight of the compound of general formula B is 0.1%-20%, for example, it can be 0.1%, 0.2%, 0.5%, 1%, 2%, 4%, 5%, 7%, 8%, 10%, 12%, 14%, 16%, 18%, 20% or the like.

In some embodiments of the present invention, in order to apply the liquid crystal composition of the present invention into liquid crystal display devices with high transmittance, the liquid crystal composition further comprises at least one compound of general formula A-1 and/or at least one compound of general formula A-2:

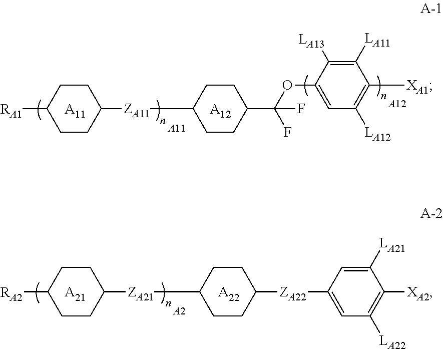

wherein, R_{A1} and R_{A2} each independently represents C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

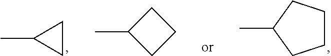

wherein, one or at least two nonadjacent —CH₂— in the C₁₋₁₂ linear alkyl, C₃₋₁₂ branched alkyl,

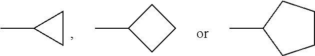

can each be independently replaced by —CH═CH—, —C≡C—, —O—, —CO—, —CO—O— or —O—CO—; and one or at least two —H in the C₁₋₁₂ linear alkyl, C₃₋₁₂ branched alkyl,

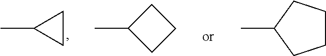

can each be independently replaced by —F or —Cl;
ring

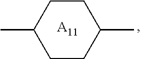

ring

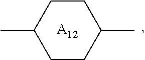

ring

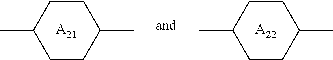

each independently represents

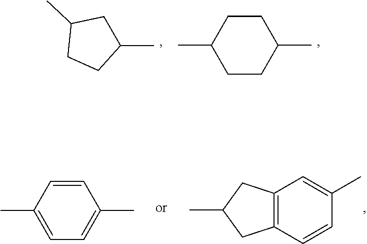

wherein, one or at least two —CH₂— in

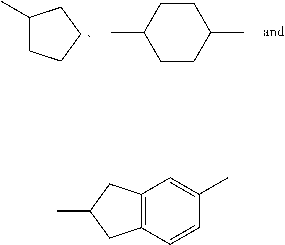

can be replaced by —O—, one or at least two single bond in the rings can be replaced by double bond; one or at least two —H on

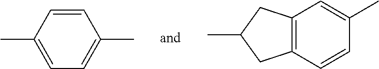

can each be independently replaced by —F, —Cl or —CN, one or at least two —CH═ in the rings can be replaced by —N═;
Z_{A11}, Z_{A21} and Z_{A22} each independently represents single bond, —CH₂CH₂—, —CF₂CF₂—, —CO—O—, —O—CO—, —O—CO—O—, —CH═CH—, —CF═CF—, —CH₂O— or —OCH₂—;
L_{A11}, L_{A12}, L_{A13}, L_{A21} and L_{A22} each independently represents —H, C₁₋₃ (for example, it can be C₁, C₂ or C₃)alkyl, or halogen atom;
X_{A1} and X_{A2} each independently represents halogen atom, C₁₋₅ (for example, it can be C₁, C₂, C₃, C₄ or C₅) halogenated linear alkyl, C₃₋₅ (for example, it can be C₃, C₄ or C₅) halogenated branched alkyl, C₁₋₅ (for example, it can be C₁, C₂, C₃, C₄ or C₅) halogenated alkoxy, C₂₋₅ (for example, it can be C₂, C₃, C₄ or C₅) halogenated alkenyl, or C₂₋₅ (for example, it can be C₂, C₃, C₄ or C₅) halogenated alkenoxy;
n_{A11} represents 0, 1, 2 or 3, wherein when nan represents 2 or 3, ring

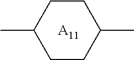

can be the same or different, and Z_{A11} can be the same or different;
n_{A12} represents 1 or 2, wherein when n_{A12} represents 2, ring

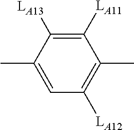

can be same or different; and
n_{A2} represents 0, 1, 2 or 3, wherein when n_{A2} represents 2 or 3, ring

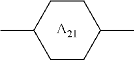

can be the same or different, and Z_{A21} can be the same or different.

In some embodiments of the present invention, the compound of general formula A-1 is any one or the combination of at least two of the compounds with the following structures:

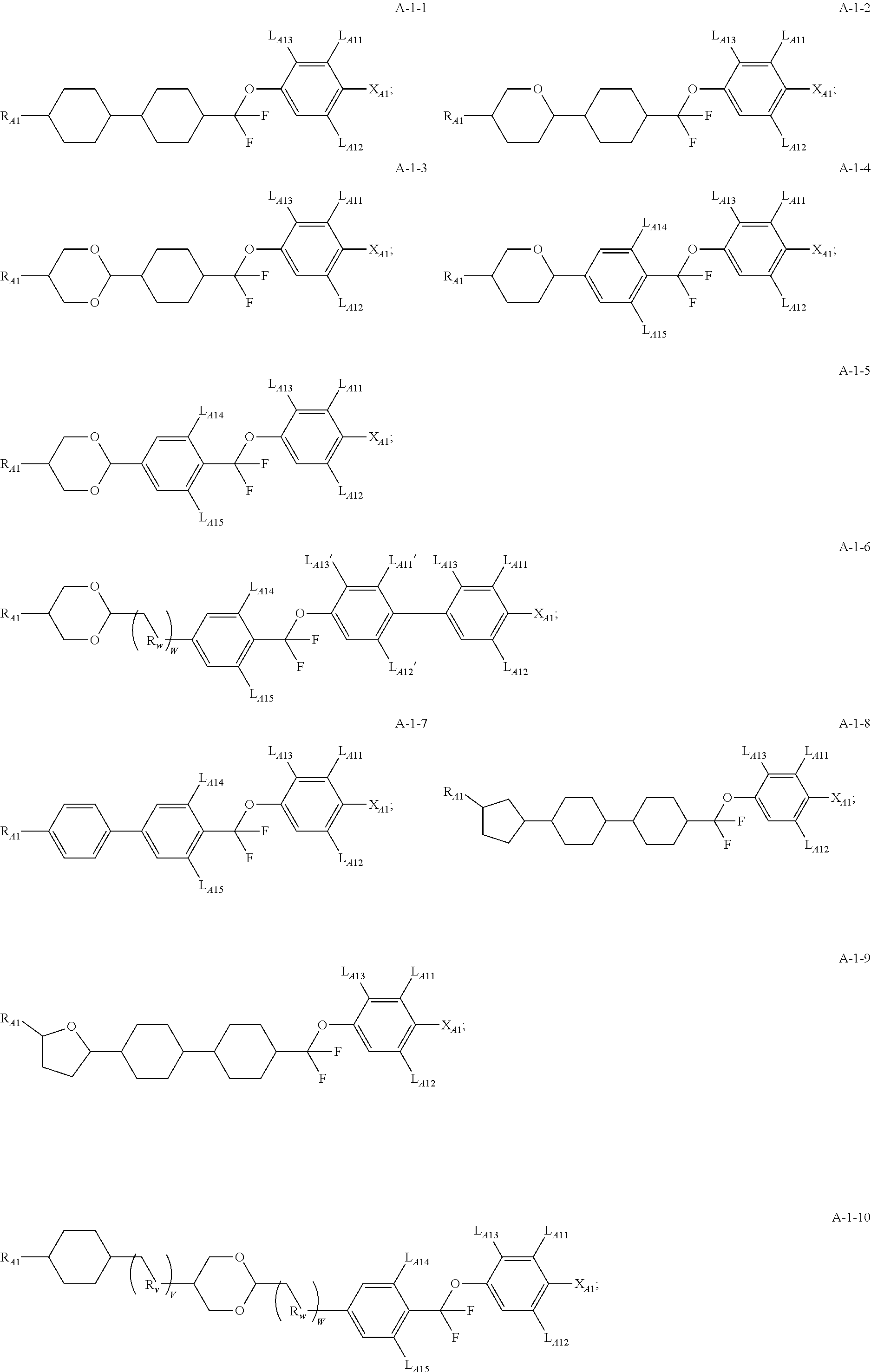

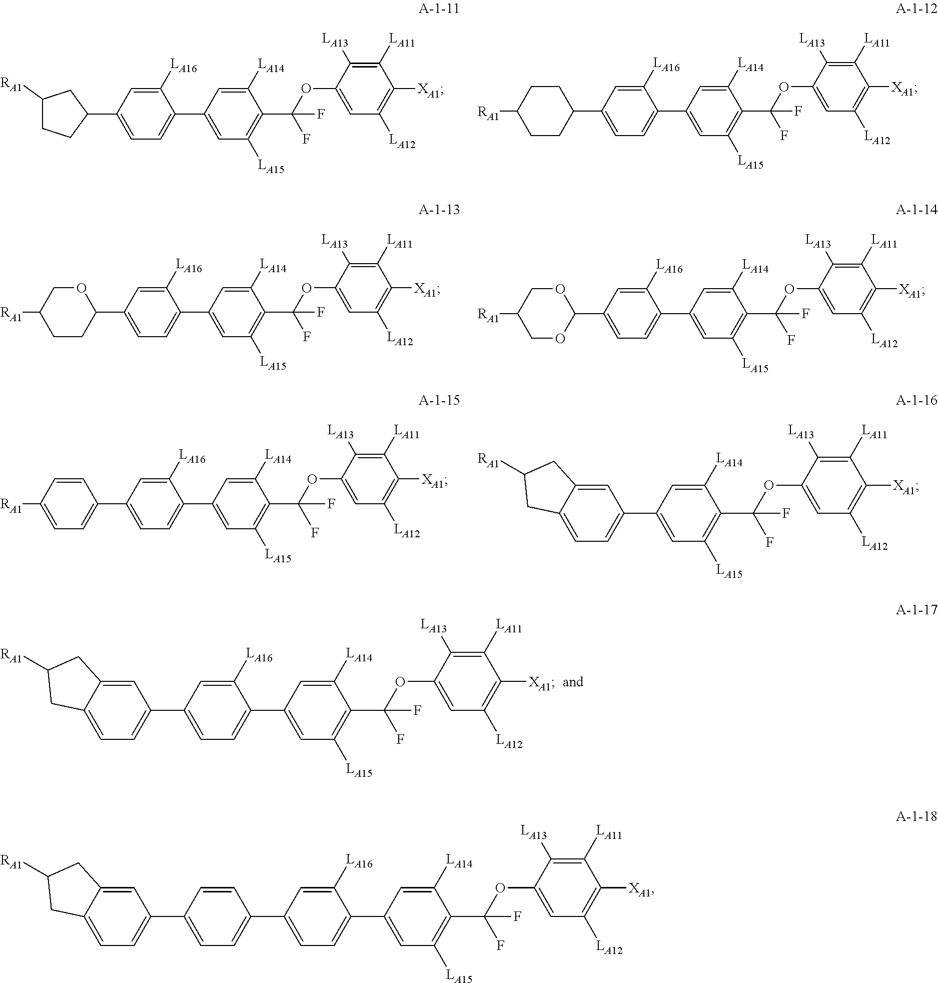

wherein, R_{A1} represents C₁₋₈ (for example, it can be C₁, C₂, C₃, C₄, C₅, C₆, C₇ or C₈) linear alkyl, C₃₋₈ (for example, it can be C₃, C₄, C₅, C₆, C₇ or C₈) branched alkyl,

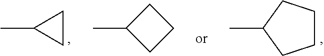

wherein, one or at least two nonadjacent —CH₂— in the C₁₋₈ linear alkyl and C₃₋₈ branched alkyl can each be independently replaced by —CH═CH—, —C≡C—, —O—, —CO—, —CO—O— or —O—CO—, and one or at least two-H in the C₁₋₈ linear alkyl, C₃₋₈ branched alkyl

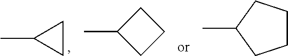

can each be independently replaced by —F or —Cl;
Rᵥ and R_{w} each independently represents —CH₂— and —O—;
v and w each independently represents 0 or 1;
L_{A11}, L_{A12}, L_{A11}′, L_{A12}′, L_{A14}, L_{A15} and L_{A16} each independently represents —H or —F;
L_{A13} and L_{A13}′ each independently represents —H or —CH₃; and
X_{A1} represents —F, —CF₃ or —OCF₃.

In some embodiments of the present invention, in the liquid crystal composition, percentage by weight of the compound of general formula A-1 is 0.1%-50%, for example, it can be 0.1%, 1%, 4%, 6%, 8%, 10%, 12%, 14%, 16%, 18%, 20%, 22%, 24%, 26%, 28%, 30%, 32%, 34%, 36%, 38%, 40%, 42%, 44%, 46%, 48%, 50% or the like.

In some embodiments of the present invention, the compound of general formula A-2 is any one or the combination of at least two of the compounds with the following structures:

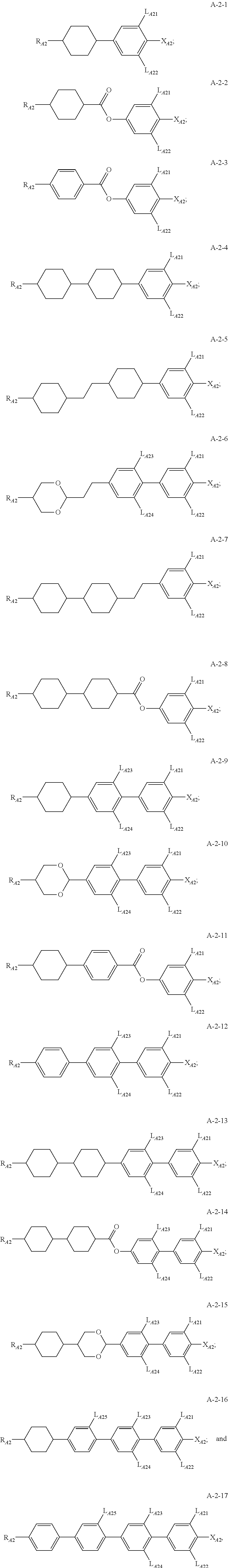

wherein, R_{A2} represents C₁₋₈ (for example, it can be C₁, C₂, C₃, C₄, C₅, C₆, C₇ or C₈) linear alkyl, C₃₋₈ (for example, it can be C₃, C₄, C₅, C₆, C₇ or C₈) branched alkyl, wherein, one or at least two nonadjacent-CH₂-in the C₁₋₈ linear alkyl and C₃₋₈ branched alkyl can each be independently replaced by —CH═CH—, —C≡C—, —O—, —CO—, —CO—O— or —O—CO—, and one or at least two-H in the C₁₋₈ linear alkyl and C₃₋₈ branched alkyl can each be independently replaced by —F or —C₁;
L_{A21}, L_{A22}, L_{A23}, L_{A24} and L_{A25} each independently represents —H or —F; and
X_{A2} represents —F, —CF₃, —OCF₃ or —CH₂CH₂CH═CF₂.

In some embodiments of the present invention, in the liquid crystal composition, percentage by weight of the compound of general formula A-2 is 0.1%-50%, for example, it can be 0.1%, 1%, 4%, 6%, 8%, 10%, 12%, 14%, 16%, 18%, 20%, 22%, 24%, 26%, 28%, 30%, 32%, 34%, 36%, 38%, 40%, 42%, 44%, 46%, 48%, 50% or the like.

In some embodiments of the present invention, in the liquid crystal composition, sum of percentages by weight of the compound of general formula A-1 and the compound of general formula A-2 is 0.1%-60%, for example, it can be 0.1%, 1%, 4%, 6%, 8%, 10%, 12%, 14%, 16%, 18%, 20%, 22%, 24%, 26%, 28%, 30%, 32%, 34%, 36%, 38%, 40%, 42%, 44%, 46%, 48%, 50%, 52%, 54%, 56%, 58%, 60% or the like.

In some embodiments of the present invention, the liquid crystal composition further comprises at least one polymerizable compound of general formula RM:

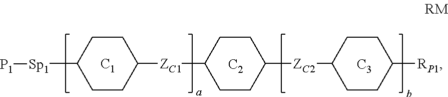

wherein, Rₚ₁ represents —H, halogen atom, —CN, -Sp₂-P₂, C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl,

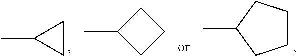

wherein, one or at least two nonadjacent —CH₂— in the C₁₋₁₂ linear alkyl, C₃₋₁₂ branched alkyl,

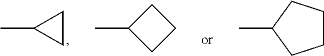

can each be independently replaced by —CH═CH—, —C≡C—, —O—, —CO—, —CO—O— or —O—CO—, and one or at least two-H can each be independently replaced by —F or —Cl;
ring

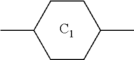

and ring

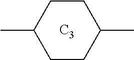

each independently represents

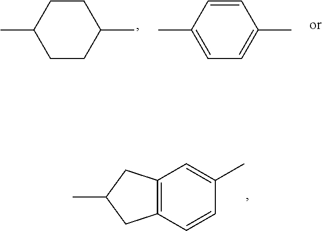

wherein, one or at least two —CH₂— in

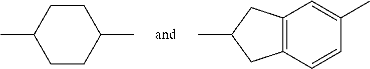

can be replaced by —O—, one or at least two single bond in the rings can be replaced by double bond; one or at least two —H on

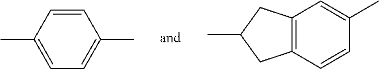

can each be independently replaced by —F, —Cl, —CN, -Sp₃-P₃, C₁₋₁₂ (for example, it can be C₁, C₂, C₃, C₄, C₅, C₆, C₇, C₈, C₉, C₁₀, C₁₁ or C₁₂) halogenated or unhalogenated linear alkyl, C₁₋₁₁ (for example, it can be C₁, C₂, C₃, C₄, C₅, C₆, C₇, C₈, C₉, C₁₀ or C₁₁) halogenated or unhalogenated linear alkoxy,

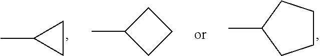

and one or at least two —CH═ in the rings can be replaced by —N═;
ring

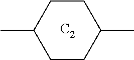

represents

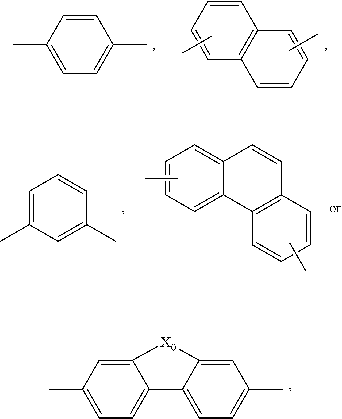

wherein one or at least two —H on ring

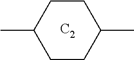

can each be independently replaced by —F, —Cl, —CN, -Sp₃-P₃, C₁₋₁₂ (for example, it can be C₁, C₂, C₃, C₄, C₅, C₆, C₇, C₈, C₉, C₁₀, C₁₁ or C₁₂) halogenated or unhalogenated linear alkyl, C₁₋₁₁ (for example, it can be C₁, C₂, C₃, C₄, C₅, C₆, C₇, C₈, C₉, C₁₀ or C₁₁) halogenated or unhalogenated linear alkoxy,

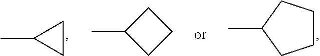

one or at least two —CH═ in the rings can each be independently replaced by —N═, X₀ represents —O—, —S—, —CO—, —CF₂—, —NH— or —NF—;
P₁, P₂ and P₃ each independently represents polymerizable group;
Sp₁, Sp₂ and Sp₃ each independently represents spacer group or single bond;
Z_{C1} and Z_{C2} Each Independently Represents —O—, —S—, —CO—, —CO—O—, —O—CO—, —O—CO—O—, —CH₂O—, —OCH₂—, —CH₂S—, —SCH₂—, —CF₂O—, —OCF₂—, —CF₂S—, —SCF₂—, —(CH₂)_{d}—, —CF₂CH₂—, —CH₂CF₂—, —(CF₂)_{d}—, —CH═CH—, —CF═CF—, —CH═CF—, —CF═CH—, —C≡C—, —CH═CH—CO—O—, —O—CO—CH═CH—, —CH₂CH₂—CO—O—, —O—CO—CH₂CH₂—, —CHR¹—, —CR¹R²— or single bond, wherein R₁ and R² each independently represents C₁₋₁₂ (for example, it can be C₁, C₂, C₃, C₄, C₅, C₆, C₇, C₈, C₉, C₁₀, C₁₁ or C₁₂) linear alkyl, C₃₋₁₂ (for example, it can be C₃, C₄, C₅, C₆, C₇, C₈, C₉, C₁₀, C₁₁ or C₁₂) branched alkyl, and d represents an integer of 1-4 (for example, it can be 1, 2, 3 or 4); and
a represents 0, 1 or 2, b represents 0 or 1, wherein when a represents 2, ring

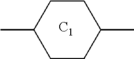

can be the same or different, and Z_{C1} can be the same or different.

The polymerizable groups involved in the present invention are groups suitable for polymerization reactions (for example, it can be radical or ionic bond polymerization, addition polymerization or condensation polymerization), or groups suitable for addition or condensation on the polymer backbone. For chain polymerization, a polymerizable group containing —CH═CH— or —C≡C— is particularly preferred, and for ring-opening polymerization, for example, an oxetane or epoxy group is particularly preferred.

In some embodiments of the present invention, the polymerizable groups P₁, P₂ and P₃ each independently represents

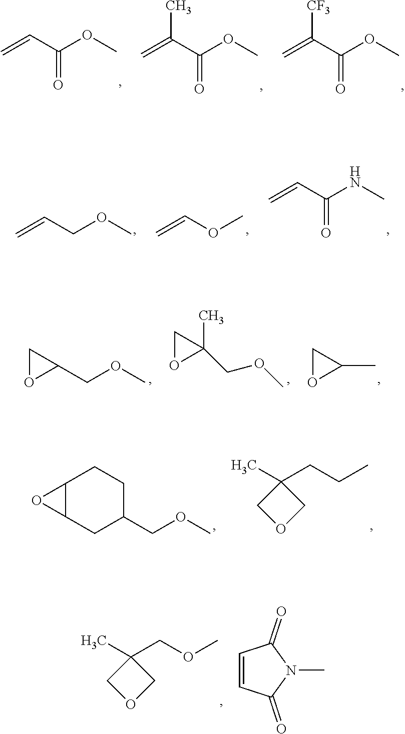

or —SH; preferably,

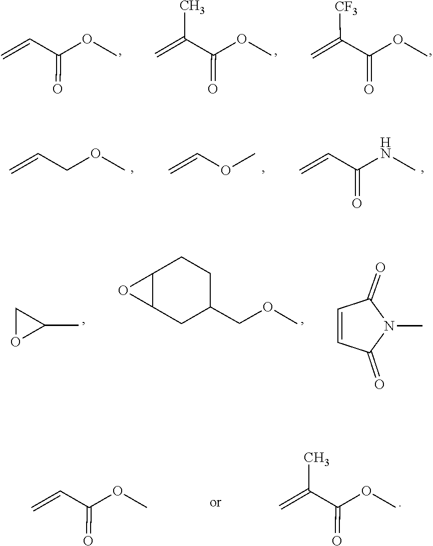

or —SH; further preferably,

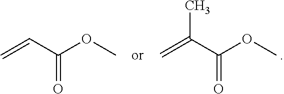

It should be noted that the term “spacer group” is known to the person skilled in the art and is described in the references (for example, Pure Appl. Chem. 2001, 73 (5), 888 and C. Tschierske, G. Pelzl, S. Diele, Angew. Chem. 2004, 116, 6340-6368). As used herein, the term “spacer group” represents a flexible group which connects the mesogenic group and the polymerizable group in a polymerizable compound. For example, —(CH₂)p₁-, —(CH₂CH₂O)q₁-CH₂CH₂—, —(CH₂CH₂S)q₁-CH₂CH₂—, —(CH₂CH₂NH)q₁-CH₂CH₂—, —CR⁰R⁰⁰—(CH₂)p₁- or —(SiR⁰R⁰⁰—O)p₁- are representative spacer groups, wherein p₁ represents an integer of 1-12, q₁ represents an integer of 1-3, R⁰ and R⁰⁰ each independently represents —H, C₁₋₁₂ linear or branched alkyl, or C₃₋₁₂ cyclic alkyl. In the present invention, the preferred spacer group is —(CH₂)p₁-, —(CH₂)p₁-O—, —(CH₂)p₁-O—CO—, —(CH₂)p₁-CO—O—, —(CH₂)p₁-O—CO—O— or —CR⁰R⁰⁰—(CH₂)p₁-.

In some embodiments of the present invention, the compound of general formula RM is any one or the combination of at least two of the compounds with the following structures:

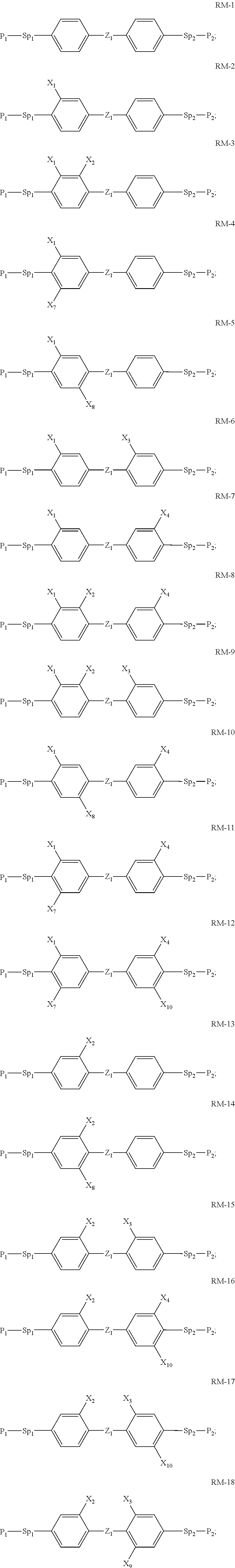

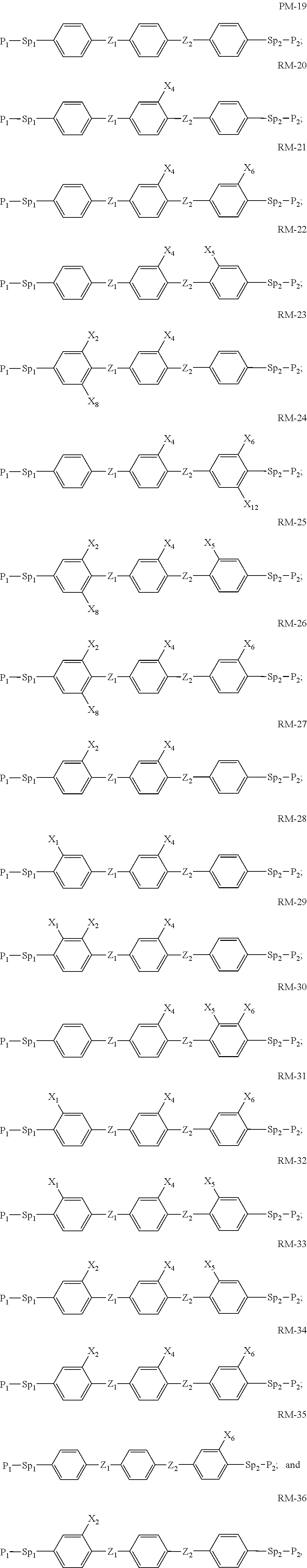

wherein, X₁-X₁₀ and X₁₂ each independently represents —F, —Cl, -Sp₃-P₃, C₁₋₅ (for example, it can be C₁, C₂, C₃, C₄ or C₅) linear alkyl, C₁₋₅ (for example, it can be C₁, C₂, C₃, C₄ or C₅)alkoxy,

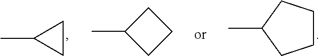

In some embodiments of the present invention, in the liquid crystal composition, percentage by weight of the polymerizable compound of general formula RM is 0.001%-5%, for example, 0.001%, 0.002%, 0.004%, 0.005%, 0.006%, 0.008%, 0.01%, 0.02%, 0.04%, 0.06%, 0.08%, 0.1%, 0.2%, 0.25%, 0.26%, 0.27%, 0.28%, 0.29%, 0.3%, 0.32%, 0.33%, 0.34%, 0.35%, 0.4%, 0.5%, 0.6%, 0.8%, 1%, 1.2%, 1.6%, 1.8%, 2%, 2.5%, 3%, 3.5%, 4%, 4.5%, 5% or the like.

In some embodiments of the present invention, the liquid crystal composition further comprises at least one additive.

The additives contain nematic liquid crystal, smectic liquid crystal, cholesteric liquid crystal, dopants, antioxidant, ultraviolet absorber, infrared absorber, polymerizable monomer or light stabilizer.

In some embodiments of the present invention, the dopant comprises any one or the combination of at least two of the following compounds:

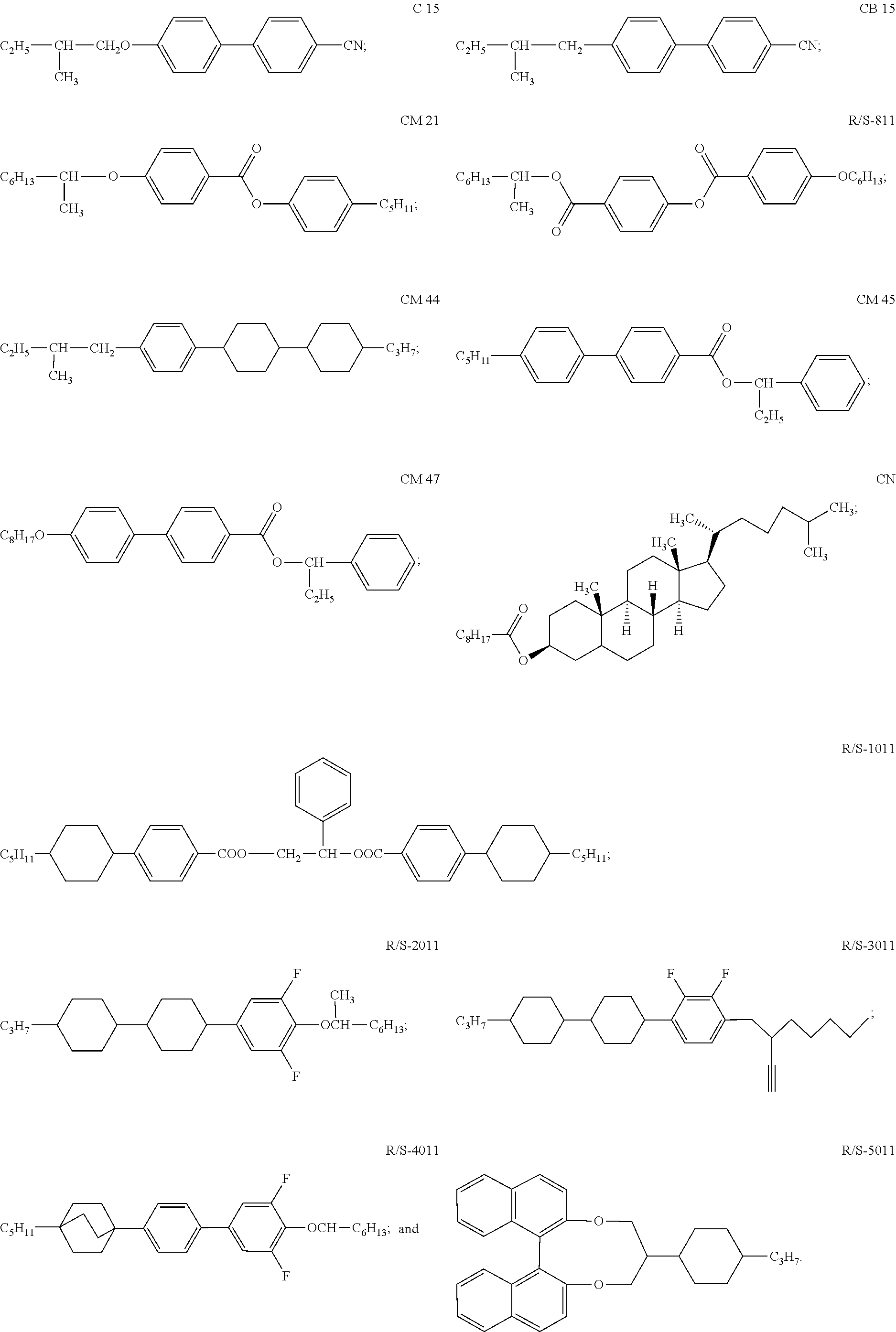

In some embodiments of the present invention, in the liquid crystal composition, percentage by weight of the dopant is 0%-5% for example, it can be 0%, 0.01%, 0.05%, 0.1%, 0.2%, 0.5%, 1%, 1.5%, 2%, 2.5%, 3%, 3.5%, 4%, 4.5%, 5%, or the like, further preferably, 0.01%-1%.

In some embodiments of the present invention, additives (such as antioxidant, light stabilizer, ultraviolet absorber and the like) are preferably to be the following compounds:

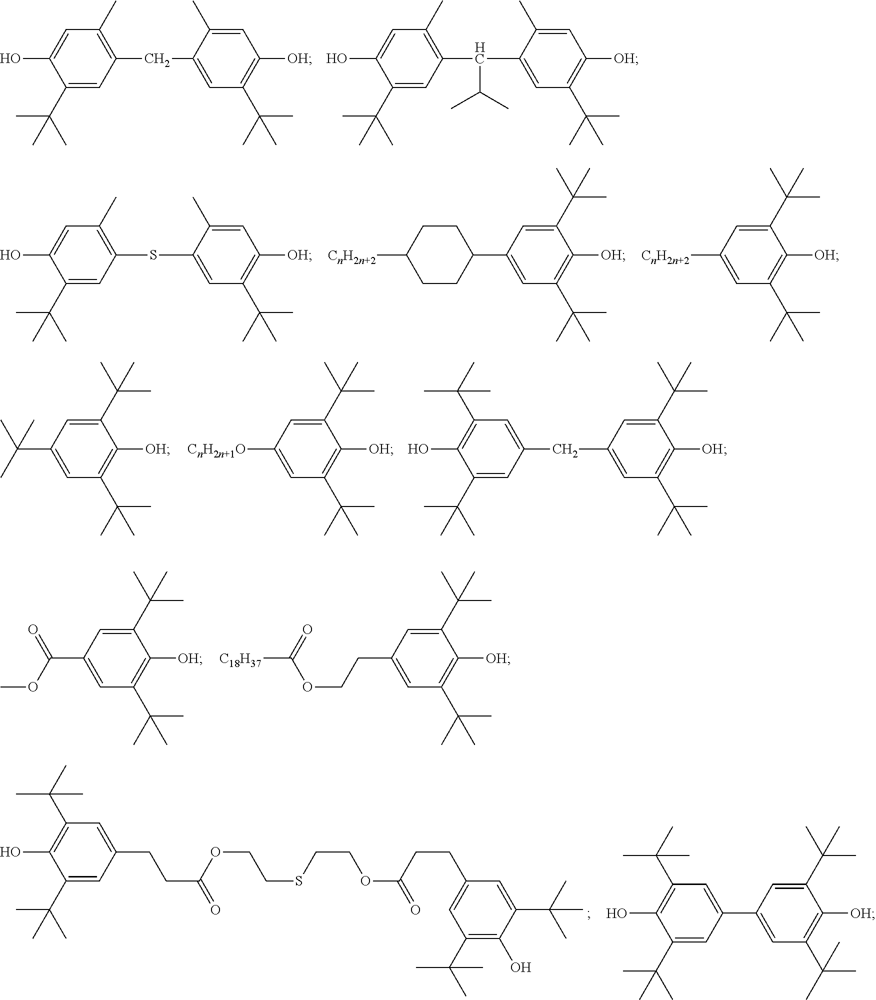

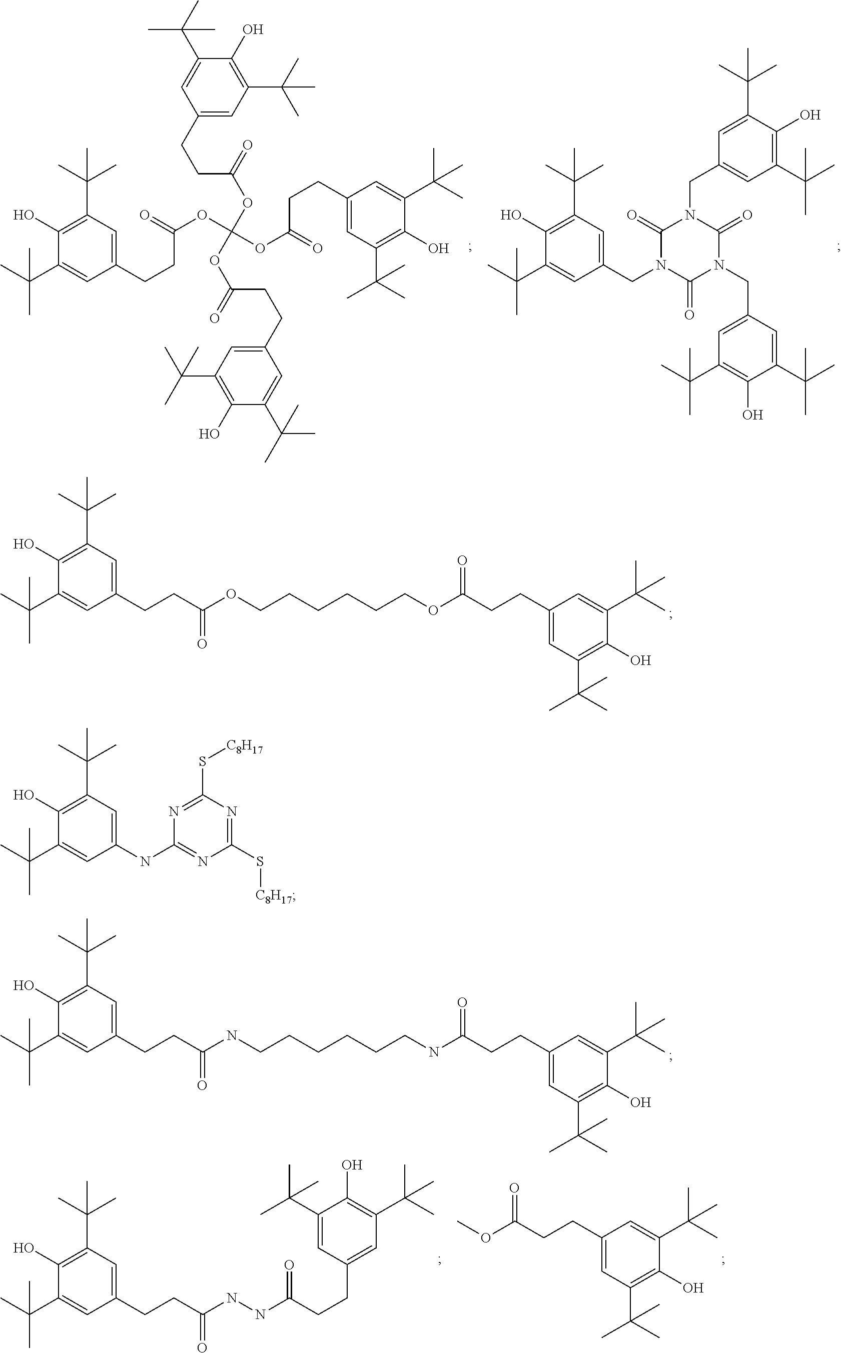

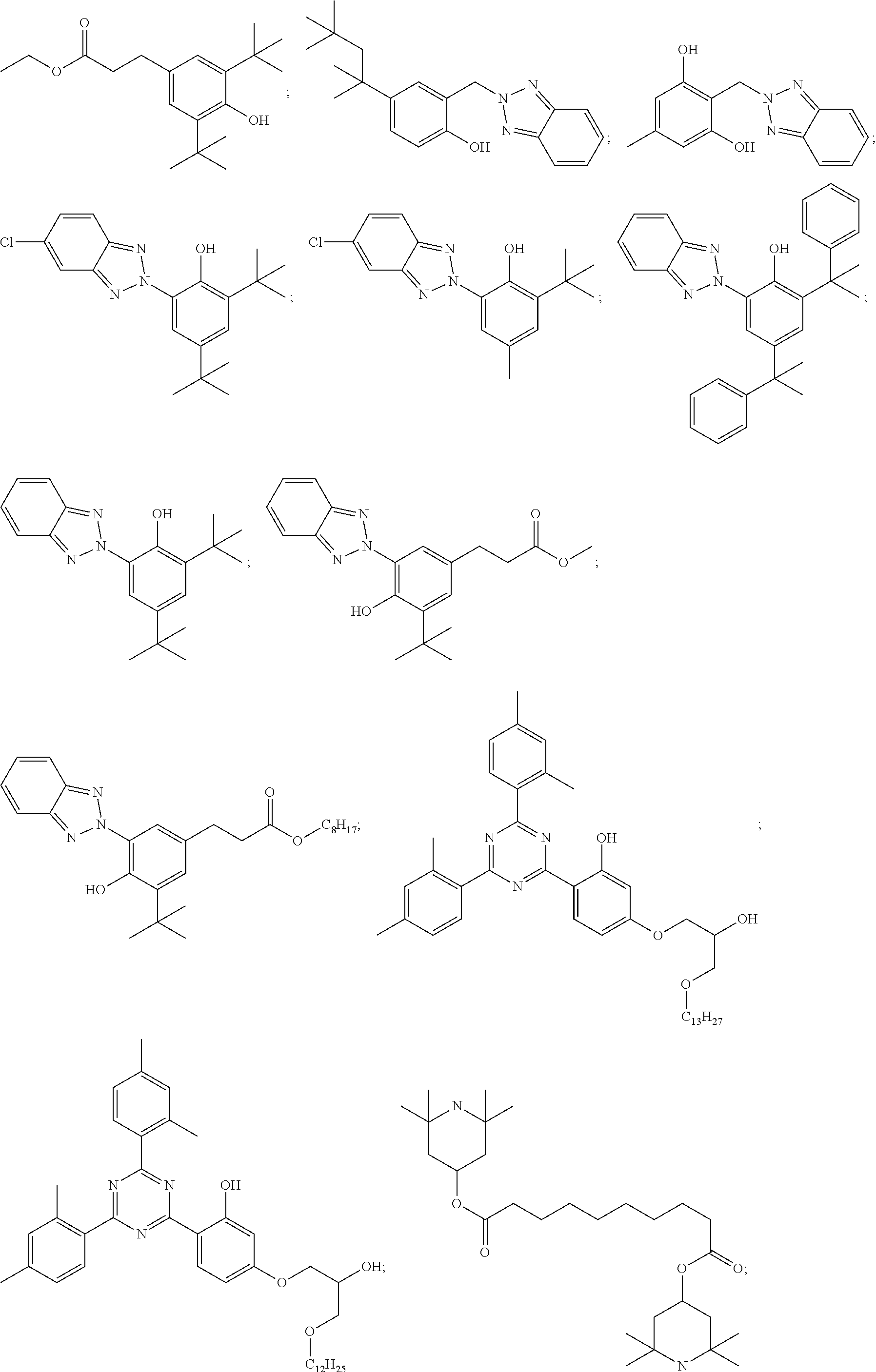

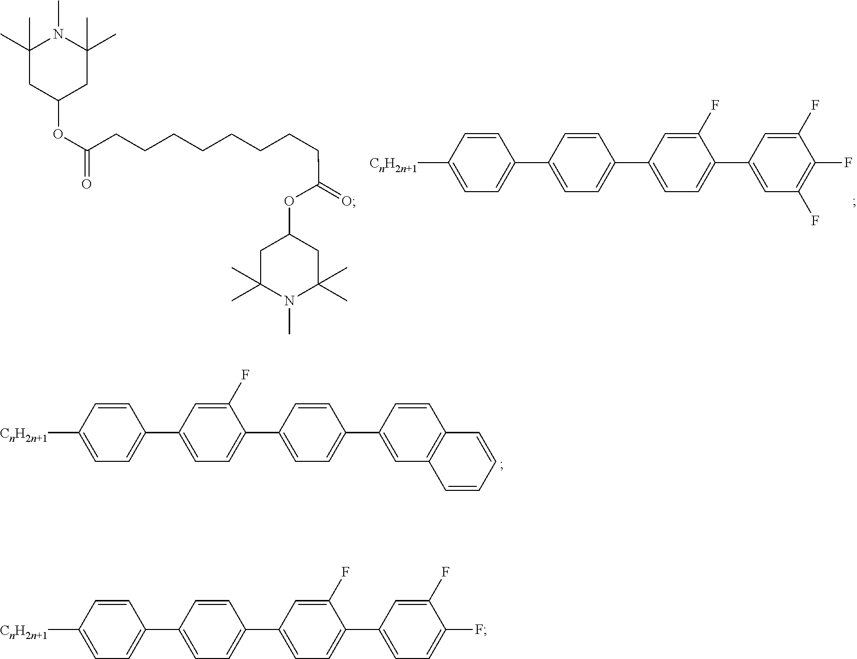

wherein, n represents a positive integer of 1-12, for example, it can be 1, 2, 4, 6, 8, 9, 10, 11, 12 or the like.

In some embodiments of the present invention, the antioxidant is selected from any one or the combination of at least two of the following compounds:

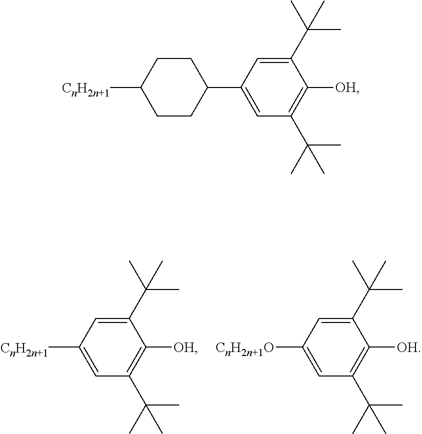

In some embodiments of the present invention, in the liquid crystal composition, percentage by weight of the light stabilizer is 0%-5%, for example, it can be 0%, 0.01%, 0.05%, 0.1%, 0.2%, 0.5%, 1%, 1.5%, 2%, 2.5%, 3%, 3.5%, 4%, 4.5%, 5% or the like, further preferably, 0.01%-1%.

It should be noted that, for an easier calculation, in the present invention, the sum of the weight percentages of the compounds having different general formulas in the liquid crystal composition is one hundred percent, and the content of the additives is not counted within the total content of the liquid crystal composition, that is, the addition of the additives will result in the total content of the components in the liquid crystal composition being >100%.

Even in the absence of the polymerization initiator, the liquid crystal composition containing polymerizable compound of the present invention can polymerize as well. However, in order to promote polymerization, polymerization initiators can be included therein. The polymerization initiator exemplarily includes, but is not limited to: benzoin ethers, benzophenones, acetophenones, benzoin bis-ethers, acyl phosphine oxides and so forth.

In a second aspect, the present invention provides a liquid crystal display device, and the liquid crystal display device comprises a liquid crystal composition as described in the first aspect.

Compared with the prior art, the present invention has the following beneficial effects:

Via designing the components of the liquid crystal composition, the liquid crystal composition prepared in the present invention has a larger Kₐᵥₑ value, a higher ε_{⊥} and a lower LC scattering, and has an appropriate optical anisotropy and clearing point at the same time, which is suitable for display elements of VA, IPS or FFS type.

### DETAILED EMBODIMENTS

For an easier understanding of the present invention, the present invention enumerates the Examples below. It should be clear for the person skilled in the art that, the Examples are only for helping to understand the present invention, and shall not be seen as specific limitations on the present invention.

The sources of some components in the Examples and Comparative Examples are as follows:

For the convenience of the expression, in the following examples, the group structures of the liquid crystal composition are represented by the codes listed in Table 1:

TABLE 1

| Unit structure of group | Code | Name of group |
|---|---|---|
| 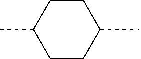 | C | 1,4-cyclohexylidene |
| 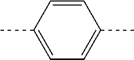 | P | 1,4-phenylene |
| 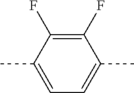 | W | 2,3-difluoro-1,4-phenylene |
| 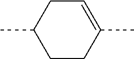 | L | 1,4-cyclohexene |
| 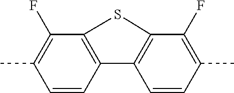 | B(S) | 4,6-difluoro-dibenzo[b,d]thiophene-3,7-diyl |
| 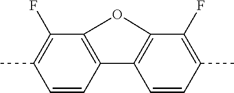 | B(O) | 4,6-difluoro-dibenzo[b,d]furan-3,7-diyl |
| 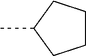 | C(5) | 1-cyclopentyl |
| 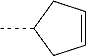 | C(5, V) | 1-cyclopentenyl |
| 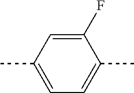 | G | 2-fluoro-1,4-phenylene |
| —O— | O | oxygen substituent |
| —C═CH— or —CH═CH₂ | V | ethenylene or ethenyl |
| 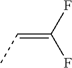 | V(2F) | difluoroenyl |
| —COO— | E | ester bridge bond |
| —CH₂O— | 1O | methyleneoxy |
| —CH₂CH₂— | 2 | ethyl bridge group |
| —CₙH₂ₙ₊₁ or —CₙH₂ₙ— | n (n | alkyl or alkylene |
| | represents | |
| | a positive | |
| | integer of | |
| | 1-12) | |

In Table 1, broken lines represent the binding sites of the groups.

Take the compound with the following structural formula as an example:

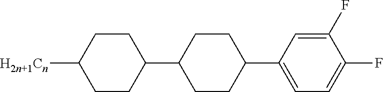

represented by the codes listed in Table 1, this structural formula can be expressed as nCCGF, n in the code represents the number of the carbon atoms of the alkyl on the left, for example, n is “3”, meaning that the alkyl is —C₃H₇, C in the code represents cyclohexylidene, G represents 2-fluoro-1,4-phenylene, and F represents fluorine.

In the following Examples and Comparative Examples, the abbreviated codes of performance test items are shown in Table 2:

TABLE 2
The abbreviated codes of the performance test items

| Code of test items | Meaning |
|---|---|
| Δn | optical anisotropy (589 nm, 20° C.) |
| Cp | clearing point (nematic-isotropy phases transition |
| | temperature, ° C.) |
| ε_{⊥} | dielectric constant perpendicular to the molecular |
| | axis |
| Kₐᵥₑ | average elastic constant (20° C.) |
| LC scattering | scattering coefficient |
| nₒ | ordinary ray refraction index |
| nₑ | extraordinary ray refraction index |

wherein, Δn, nₒ, nₑ: tested using an Abbe Refractometer under a sodium lamp (589 nm) light source at 20° C.;
Cp (° C.): tested by melting point apparatus quantitative method;
ε_{⊥}: test conditions: 20° C., 1 KHz, VA-type test cell with a cell gap of 6 μm;
Kₐᵥₑ: Kₐᵥₑ=(K₁₁+K₂₂+K₃₃)/3, wherein K₁₁, K₂₂ and K₃₃ are obtained via testing the capacitance-voltage characteristic curves (C-V curves) of liquid crystal by LCR meter and VA test cell and calculating; test conditions: 6 μm VA test cell, V=0.1~20 V;

$$Lc scattering : LC Scattering = \frac{d \cdot Δ {n}^{2} \cdot {( {n}_{e} + {n}_{o} )}^{2}}{{K}_{ave}} .$$

The components used in the following Examples can either be synthesized by methods known in the art or be obtained commercially. Each of the obtained liquid crystal compositions is tested to meet the standards of electronic compound.

In the following Examples, the liquid crystal compositions are mixed according to proportion of each component (it is the general formula to which the component belong in the bracket at the end of the code of the component in each Example) and via conventional preparing methods (such as method of heating, ultrasonic processing, suspending and so forth) to obtain the liquid crystal compositions.

### Comparative Example 1

The present Comparative Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3PWO2 (N-13) | 5.5 | Δn | 0.094 |
| 2CCWO2 (N-7) | 9.5 | Cp | 106 |
| 3CCWO2 (N-7) | 9 | ε_{⊥} | 6.5 |
| 3CC1OWO2 (II-1) | 8 | Kₐᵥₑ | 16.2 |
| 3CPWO2 (N-15) | 7 | LC scattering | 0.0178 |
| 3CLWO3 (N-10) | 9 | | |
| C(5)1OB(S)O2 | 4 | | |
| C(5)1OB(S)O4 | 4 | | |
| 3CCV (M-1) | 30 | | |
| 3CC2 (M-1) | 3 | | |
| 3CPO1 (M-2) | 3 | | |
| 3CCV1 (M-1) | 5 | | |
| 3CPPC2 (M-23 | 1.5 | | |
| VCCP1 (M-11) | 1.5 | | |

### Comparative Example 2

The present Comparative Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3PWO2 (N-13) | 9.5 | Δn | 0.093 |
| 2CCWO2 (N-7) | 8.5 | Cp | 106 |
| 3C2WO2 (II-4) | 10 | ε_{⊥} | 6 |
| 4CCWO2 (N-7) | 10 | Kₐᵥₑ | 16.1 |
| 3CPWO2 (N-15) | 9 | Lc scattering | 0.0175 |
| 3CLWO3 (N-10) | 9 | | |
| 3CCV (M-1) | 30 | | |
| 3CCP1 (M-11) | 4 | | |
| 3CC1OC3 (M-21) | 5 | | |
| 3PPO2 (M-4) | 2 | | |
| 3CGPC2 (M-24) | 1.5 | | |
| 3CPP2 (M-13) | 1.5 | | |

### Example 1

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3PWO2 (N-13) | 5.5 | Δn | 0.093 |
| 2CCWO2 (N-7) | 9.5 | Cp | 107 |
| 3CCWO2 (N-7) | 9 | ε_{⊥} | 6.9 |
| 3CC1OWO2 (II-1) | 8 | Kₐᵥₑ | 17.4 |
| 3CPWO2 (N-15) | 7 | Lc scattering | 0.016 |
| 3CLWO3 (N-10) | 9 | | |
| C(5,V)1OB(S)O2 (I-1) | 4 | | |
| C(5,V)1OB(S)O4 (I-1) | 4 | | |
| 3CCV (M-1) | 30 | | |
| 3CC2 (M-1) | 3 | | |
| 3CPO1 (M-2) | 3 | | |
| 3CCV1 (M-1) | 5 | | |
| 3CPPC2 (M-23) | 1.5 | | |
| VCCP1 (M-11) | 1.5 | | |

It can be seen from the comparison of Example 1 and Comparative Examples 1-2 that the liquid crystal composition of the present invention, via the optimization on the structures of the compound of general formula I and the compound of general formula II, the liquid crystal composition of the present invention has an appropriate optical anisotropy, an appropriate clearing point, a larger ε_{⊥}, a larger Kₐᵥₑ value and a smaller scattering coefficient (the ratios has been decreased by 11%-9%), and the contrast rate is correspondingly improved by 11%-9%.

### Example 2

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3PWO2 (N-13) | 5.5 | Δn | 0.093 |
| 2CCWO2 (N-7) | 9.5 | Cp | 106 |
| 3CCWO2 (N-7) | 9 | ε_{⊥} | 6.7 |
| 3CC2WO2 (II-2) | 8 | Kₐᵥₑ | 18 |
| 3CPWO2 (N-15) | 7 | Lc scattering | 0.0157 |
| 3C1OWO2 (II-3) | 9 | | |
| C(5,V)1OB(S)O2 (I-1) | 4 | | |
| C(5,V)1OB(S)O4 (I-1) | 4 | | |
| 3CCV (M-1) | 30 | | |
| 3CC2 (M-1) | 3 | | |
| 3CPO1 (M-2) | 3 | | |
| 3CCV1 (M-1) | 5 | | |
| 3CPPC2 (M-23) | 1.5 | | |
| VCCP1 (M-11) | 1.5 | | |

### Example 3

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3PWO2 (N-13) | 3.5 | Δn | 0.093 |
| 2CCWO2 (N-7) | 8.5 | Cp | 106 |
| 3C2WO2 (II-4) | 10 | ε_{⊥} | 7.2 |
| 3CC1OWO2 (II-1) | 10 | Kₐᵥₑ | 19.1 |
| 3CPWO2 (N-15) | 5 | Lc scattering | 0.0148 |
| 3CLWO3 (N-10) | 9 | | |
| C(5,V)1OB(S)O2 (I-1) | 5 | | |
| C(5,V)1OB(S)O4 (I-1) | 5 | | |
| 3CCV (M-1) | 30 | | |
| 3CCP1 (M-11) | 4 | | |
| 3CC1OC3 (M-21) | 5 | | |
| 3PPO2 (M-4) | 2 | | |
| 3CGPC2 (M-24) | 1.5 | | |
| 3CPP2 (M-13) | 1.5 | | |

### Example 4

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 2C2WO2 (II-4) | 5 | Δn | 0.09 |
| 3C2WO2 (II-4) | 5 | Cp | 105 |
| 2CC2WO2 (II-2) | 8 | ε_{⊥} | 8.2 |
| 3CC2WO4 (II-2) | 8 | Kₐᵥₑ | 22.4 |
| 3CC2WO2 (II-2) | 8 | Lc scattering | 0.0121 |
| 4CC2WO3 (II-2) | 7 | | |
| C(5,V)1OB(S)O1 (I-1) | 5 | | |
| C(5,V)1OB(S)O2 (I-1) | 5 | | |
| C(5,V)1OB(S)O3 (I-1) | 5 | | |
| C(5,V)1OB(O)O4 (I-1) | 5 | | |
| 3CC1OWO2 (II-1) | 5 | | |
| 3CCV (M-1) | 27 | | |
| 4CC3 (M-1) | 4 | | |
| V2CCP1 (M-11) | 2 | | |
| 3CCEPC3 (M-27) | 1 | | |

### Example 5

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3CWO2 (N-2) | 2 | Δn | 0.09 |
| 3C1OWO2 (II-3) | 8 | Cp | 105 |
| 2CC1OWO2 (II-1) | 12 | ε_{⊥} | 8.7 |
| 3CC1OWO2 (II-1) | 8 | Kₐᵥₑ | 21 |
| 2CC2WO2 (II-2) | 8 | Lc scattering | 0.0126 |
| 3CC2WO2 (II-2) | 10 | | |
| 4CC2WO3 (II-2) | 5 | | |
| 20B(O)OV(2F)(B-1-1) | 3 | | |
| 40B(S)OV(2F) (B-1-1) | 2 | | |
| C(5,V)1OB(S)O2 (I-1) | 2 | | |
| C(5,V)1OB(O)O4 (I-1) | 4 | | |
| 3CCV (M-1) | 32 | | |
| 3CPP2V (M-13) | 2 | | |
| 3CPP2V1 (M-13) | 2 | | |

### Example 6

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 2C1OWO2 (II-3) | 4.5 | Δn | 0.089 |
| 3C1OWO2 (II-3) | 5 | Cp | 105 |
| 2CC1OWO2 (II-1) | 11 | ε_{⊥} | 9.3 |
| 3CC1OWO2 (II-1) | 10 | Kₐᵥₑ | 20.9 |
| 4CC1OWO2 (II-1) | 5 | Lc scattering | 0.0126 |
| 3C2WO2 (II-4) | 5 | | |
| 2CC2WO2 (II-2) | 7 | | |
| 3CC2WO2 (II-2) | 8.5 | | |
| C(5,V)1OB(S)O3 (I-1) | 4 | | |
| C(5,V)1OB(S)O2 (1-1) | 4 | | |
| C(5,V)1OB(O)O4 (I-1) | 4 | | |
| 3CCV (M-1) | 30 | | |
| 3CCP1 (M-13) | 2 | | |

### Example 7

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3C1OWO2 (II-3) | 11 | Δn | 0.091 |
| 2CC1OWO2 (II-1) | 10 | Cp | 105 |
| 3CC1OWO2 (II-1) | 10 | ε_{⊥} | 8.6 |
| 1VCPWO2 (N-15) | 5 | Kₐᵥₑ | 19.3 |
| 3PPWO2 (N-17) | 2 | Lc scattering | 0.014 |
| 3CLWO2 (N-10) | 9 | | |
| 3LWO2 (N-3) | 5 | | |
| C(5,V)1OB(S)O2 (I-1) | 5 | | |
| C(5,V)1OB(S)O4 (I-1) | 5 | | |
| 3CCV (M-1) | 28 | | |
| 3CPPO2 (M-13) | 3 | | |
| 3CC2 (M-1) | 4 | | |
| 3CPPC2 (M-23 | 1.5 | | |
| V2CCP1 (M-11) | 1.5 | | |

### Example 8

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3PWO2 (N-13) | 7.5 | Δn | 0.093 |
| 2CCWO2 (N-7) | 9.5 | Cp | 106 |
| 3CCWO2 (N-7) | 6 | ε_{⊥} | 6.7 |
| 3CC1OWO2 (II-1) | 6 | Kₐᵥₑ | 17.8 |
| 2CC2WO2 (II-2) | 5 | Lc scattering | 0.0159 |
| 3CPWO2 (N-15) | 9 | | |
| 3CLWO3 (N-10) | 9 | | |
| 2OB(S)OV(2F) (I-9) | 2 | | |
| C(5,V)1OB(S)O2 (I-1) | 2 | | |
| 3CCV (M-1) | 31 | | |
| 3CCV1 (M-1) | 10 | | |
| VCCP1 (M-11) | 3 | | |

### Example 9

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3PWO2 (N-13) | 7.5 | Δn | 0.09 |
| 2CC1OWO2 (II-1) | 5.5 | Cp | 104 |
| 2CC2WO2 (II-2) | 6 | ε_{⊥} | 7 |
| 3CC1OWO2 (II-1) | 10 | Kₐᵥₑ | 18.3 |
| 3CC2WO2 (II-2) | 10 | Lc scattering | 0.0144 |
| 3CPWO2 (N-15) | 4 | | |
| 3CLWO3 (N-10) | 9 | | |
| 2OB(S)OV(2F) (I-9) | 2 | | |
| C(5,V)1OB(S)O4 (I-1) | 2 | | |
| 3CCV (M-1) | 32 | | |
| 3CCV1 (M-1) | 10 | | |
| 2CPP1 (M-13) | 2 | | |

### Example 10

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3C2WO2 (II-4) | 4.5 | Δn | 0.09 |
| 2C1OWO2 (II-3) | 5 | Cp | 103 |
| 2CC1OWO2 (II-1) | 11 | ε_{⊥} | 7.5 |
| 3CC1OWO2 (II-1) | 7 | Kₐᵥₑ | 19.8 |
| 2CC2WO2 (II-2) | 7 | Lc scattering | 0.013 |
| 3CC2WO2 (II-2) | 8.5 | | |
| 3CLWO3 (N-10) | 5 | | |
| 2OB(S)OV(2F) (I-9) | 4 | | |
| C(5,V)1OB(S)O4 (I-1) | 4 | | |
| 3CCV (M-1) | 33 | | |
| 1PP2V (M-4) | 2 | | |
| 5CC2 (M-1) | 7 | | |
| 3CCP1 (M-11) | 2 | | |

### Example 11

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3C2WO2 (II-4) | 2 | Δn | 0.09 |
| 2C1OWO2 (II-3) | 3 | Cp | 102 |
| 2CC1OWO2 (II-1) | 10 | ε_{⊥} | 8.1 |
| 2CC2WO2 (II-2) | 7 | Kₐᵥₑ | 20.8 |
| 3CC2WO2 (II-2) | 8 | Lc scattering | 0.0127 |
| 4CC2WO3 (II-2) | 5 | | |
| 2OB(S)OV(2F) (I-9) | 5 | | |
| 40B(O)OV(2F) (I-9) | 5 | | |
| C(5,V)1OB(S)O2 (I-1) | 5.5 | | |
| C(5,V)1OB(O)O4 (I-1) | 5.5 | | |
| 3CCV (M-1) | 35 | | |
| 3CPO1 (M-2) | 2 | | |
| 4CC3 (M-1) | 7 | | |

### Example 12

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 2C2WO2 (II-4) | 8 | Δn | 0.088 |
| 3C1OWO2 (II-3) | 8 | Cp | 103 |
| 2CC1OWO2 (II-1) | 13 | ε_{⊥} | 8.3 |
| 2CC2WO2 (II-2) | 8 | Kₐᵥₑ | 21 |
| 3CC2WO2 (II-2) | 10 | Lc scattering | 0.012 |
| 4CC2WO3 (II-2) | 5 | | |
| 20B(O)OV(2F) (I-9) | 4 | | |
| 40B(S)OV(2F) (I-9) | 4 | | |
| C(5,V)1OB(S)O2 (I-1) | 3 | | |
| C(5,V)1OB(O)O4(I-1) | 4 | | |
| 3CCV (M-1) | 30 | | |
| 4CC3 (M-1) | 3 | | |

### Example 13

The present Example provides a liquid crystal composition comprising components in the percentages by weight as shown in the table below, and the performance tests are carried out by filling the same into the two substrates of the liquid crystal display device:

| Code of component | Content | Test result of performance parameters | |
|---|---|---|---|
| 3C2WO2 (II-4) | 4.5 | Δn | 0.089 |
| 2C1OWO2 (II-3) | 3 | Cp | 103 |
| 2CC1OWO2 (II-1) | 11 | ε_{⊥} | 7.9 |
| 3CC1OWO2 (II-1) | 8 | Kₐᵥₑ | 20.3 |
| 2CC2WO2 (II-2) | 7 | Lc scattering | 0.0127 |
| 3CC2WO2 (II-2) | 8.5 | | |
| 20B(O)OV(2F) (I-9) | 4 | | |
| 40B(S)OV(2F) (I-9) | 4 | | |
| C(5,V)1OB(S)O2 (1-1) | 3 | | |
| C(5,V)1OB(O)O4 (I-1) | 3 | | |
| 3CCV (M-1) | 35 | | |
| 4CC3 (M-1) | 7.5 | | |
| 3CGPC3 (M-24) | 1.5 | | |

It can be seen from the above contents that via designing the components of the liquid crystal composition, the liquid crystal composition prepared in the present invention has a larger Kₐᵥₑ value, a higher &1 and a lower LC scattering ((the ratios has been decreased by 9%-48%)), and has an appropriate optical anisotropy and clearing point at the same time, which makes the liquid crystal display device containing the same have a better transmission and contrast rate, and suitable for display elements of VA, IPS or FFS type.

The applicant declares that the liquid crystal composition and liquid crystal display device of the present invention is illustrated by the above Examples, but the present invention is not limited to the above Examples, that is, it does not mean that the implement of the present application must rely on the above Examples. It shall be clear to the person skilled in the art that any improvements of the present invention, equivalent replacements of the raw materials used in the present invention, the additions of any auxiliary components, the selection of specific methods or the like all fall into the protection scope and the disclosure scope of the present invention.

### INDUSTRIAL APPLICABILITY

The liquid crystal composition involved in the present invention can be applied to the liquid crystal field.

1. A liquid crystal composition, wherein the liquid crystal composition comprises at least one compound of general formula I and at least one compound of general formula II: 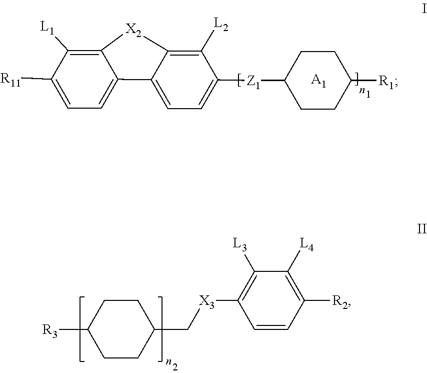
wherein, R₁ represents any one of C₁₋₁₂ halogenated or unhalogenated linear alkyl, C₃₋₁₂ halogenated or unhalogenated branched alkyl, 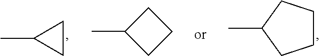
wherein, one or at least two nonadjacent —CH₂— group in the C₁₋₁₂ halogenated or unhalogenated linear alkyl and C₃₋₁₂ halogenated or unhalogenated branched alkyl can each be independently replaced by —CH═CH—, —C≡C—, —O—, —CO—, —CO—O— or —O—CO— group;
R₁₁ represents 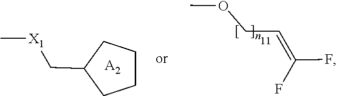
X₁ represents —O— or —S—, n₁₁ represents 0, 1, 2, 3 or 4;
ring 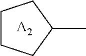
represents 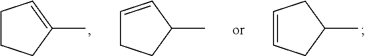
R₂ and R₃ each independently represents any one of C₁₋₁₂ linear alkyl, C₃₋₁₂ branched alkyl, 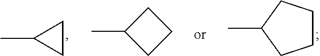
wherein, one or at least two nonadjacent —CH₂— group in the C₁₋₁₂ linear alkyl and C₃₋₁₂ branched alkyl can each be independently replaced by —CH═CH—, —C≡C—, —O—, —CO—, —CO—O— or —O—CO— group;
ring 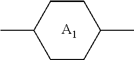
represents 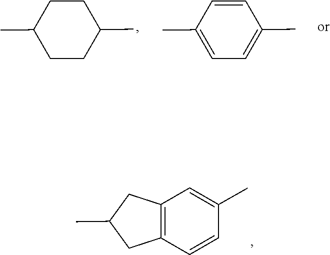
wherein one or at least two —CH₂— in 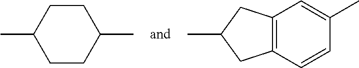
can each be independently replaced by —O—, one or at least two single bond in the rings can each be independently replaced by double bond; one or at least two —H on 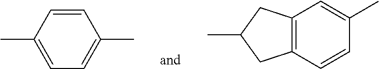
can each be independently replaced by —F, —Cl, —CN, —CH₃ or —OCH₃, one or at least two —CH═ in the rings can each be independently replaced by —N═;
L₁-L₄ each independently represents halogen atom;
X₂ represents —O— or —S—; X₃ represents —O— or —CH₂—;
Z₁ represents single bond, —CO—O—, —O—CO—, —CH₂O—, —OCH₂—, —CH═CH—, —C≡C—, —CH₂CH₂—, —CF₂CF₂—, —(CH₂)₄—, —CF₂O— or —OCF₂—;
n₁ represents 0, 1 or 2, when n₁ represents 2, ring 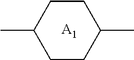
can be the same or different, Z₁ can be the same or different; and
n₂ represents 1 or 2.

2. The liquid crystal composition according to claim 1, wherein the compound of general formula I is any one or the combination of at least two of the compounds with the following structures: 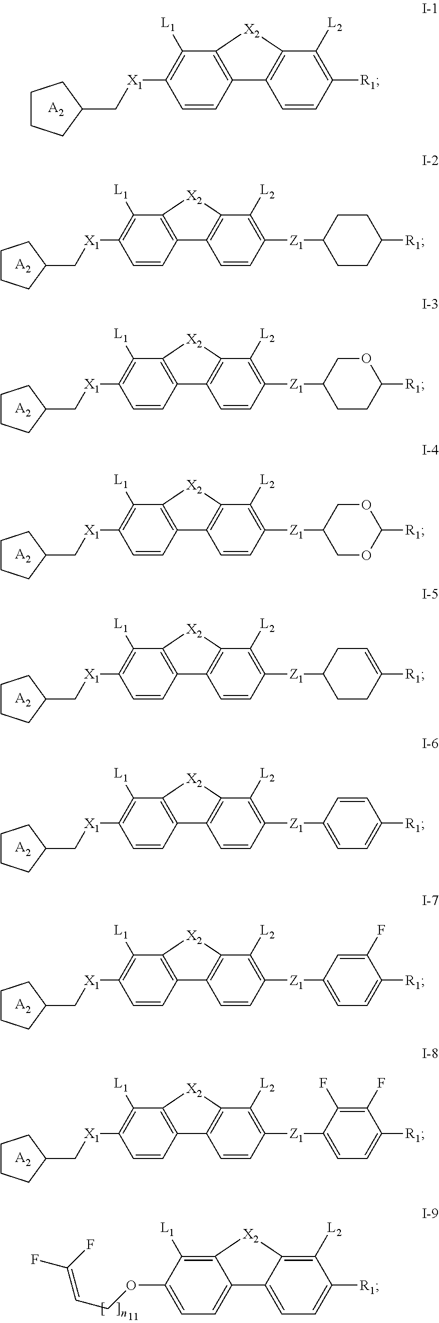 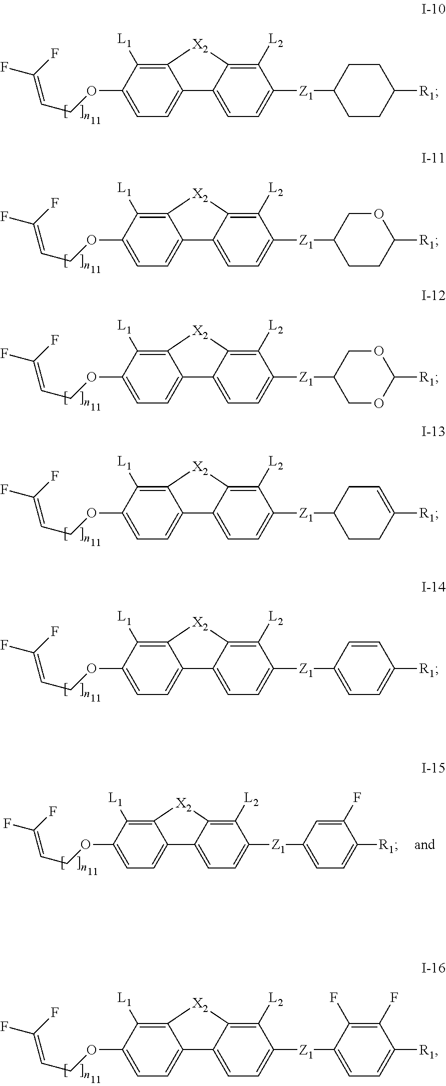
wherein, ring 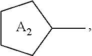
X₁, X₂, L₁, L₂, Z₁ and n₁₁ have the same protection scopes as those in claim 1.

3. The liquid crystal composition according to claim 1, wherein the compound of general formula II is any one or the combination of at least two of the compounds with the following structures: 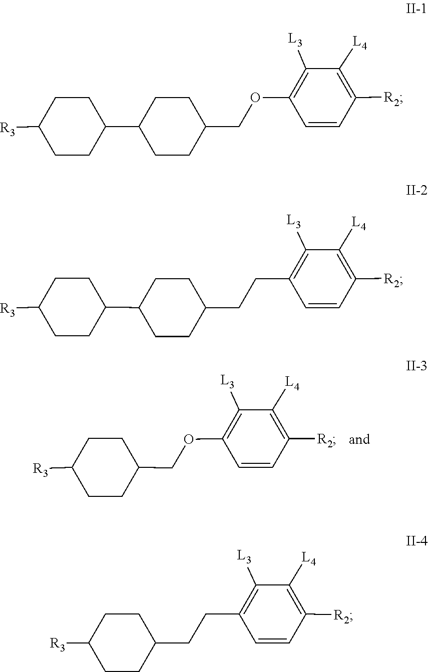
preferably, L₃ and L₄ both represent fluorine atom;
preferably, in the liquid crystal composition, percentage by weight of the compound of general formula II is 0.1%~60%.

4. The liquid crystal composition according to claim 1, wherein the liquid crystal composition further comprises at least one compound of general formula N: 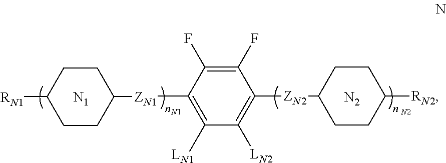
wherein, R_{N1} and R_{N2} each independently represents C₁₋₁₂ linear alkyl, C₃₋₁₂ branched alkyl, 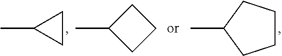
wherein, one or any more than two nonadjacent —CH₂— in the C₁₋₁₂ linear alkyl and C₃₋₁₂ branched alkyl can each be independently replaced by —CH═CH—, —C≡C—, —O—, —CO—, —CO—O— or —O—CO—;
ring 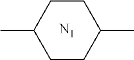
and ring 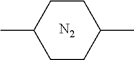
each independently represents 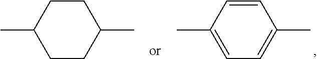
wherein one or at least two —CH₂— in 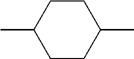
can be replaced by —O—, one or at least two single bond in the rings can be replaced by double bond; one or at least two —H on 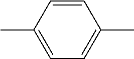
can each be independently replaced by —F, —Cl or —CN, one or at least two —CH═ in the rings can be replaced by —N═;
Z_{N1} and Z_{N2} each independently represents single bond, —CO—O—, —O—CO—, —CH═CH—, —C≡C—, —CF₂CF₂—, —(CH₂)₄—, —CF₂O— or —OCF₂—;
L_{N1} and L_{N2} each independently represents —H, C₁₋₃ alkyl, or halogen atom; and
n_{N1} represents 0, 1, 2 or 3, n_{N2} represents 0 or 1, and 0≤n_{N1}+n_{N2}≤3, wherein, when n_{N1} represents 2 or 3, ring 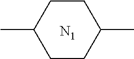
can be the same or different, Z_{N1} can be the same or different.

5. The liquid crystal composition according to claim 4, wherein the compound of general formula Nis any one or the combination of at least two of the compounds with the following structures: 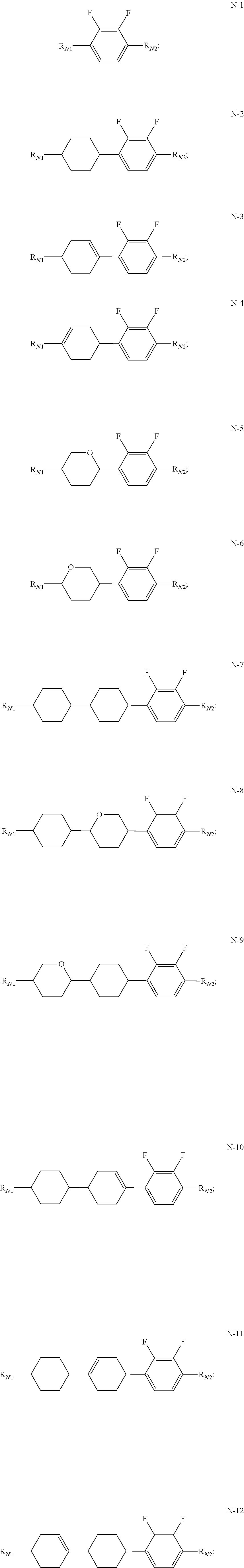 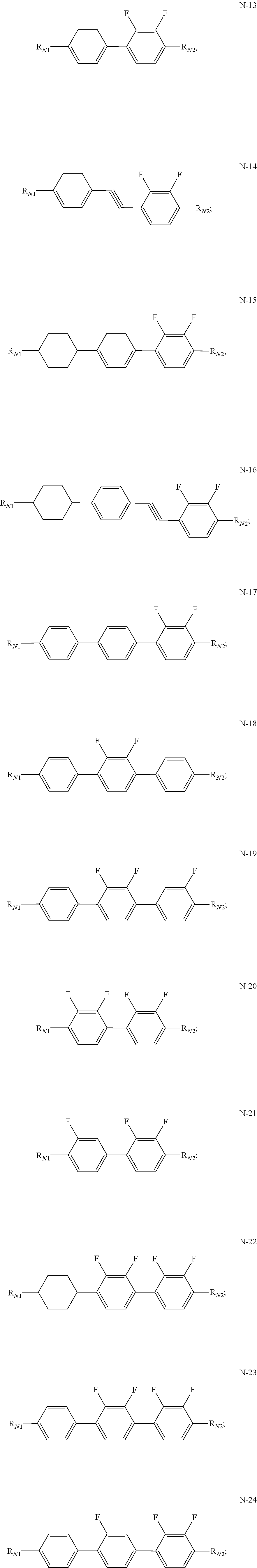 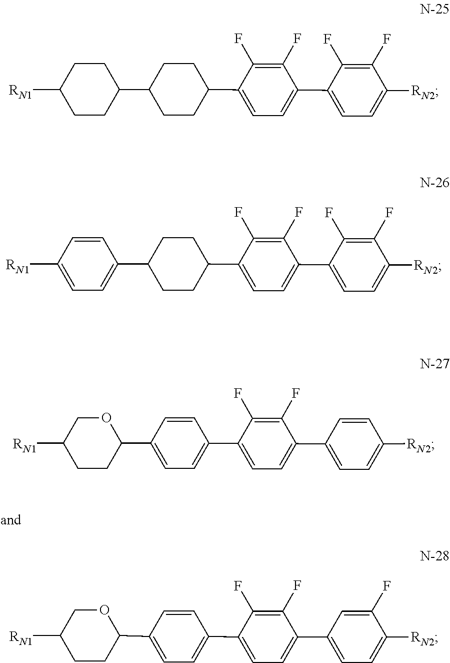
preferably, in the liquid crystal composition, percentage by weight of the compound of general formula N is 0.1%~50%.

6. The liquid crystal composition according to claim 1, wherein the liquid crystal composition further comprises at least one compound of general formula M: 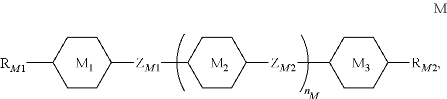
wherein, R_{M1} and R_{M2} each independently represents C₁₋₁₂ linear alkyl, C₃₋₁₂ branched alkyl, 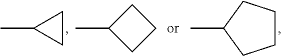
wherein, one or at least two nonadjacent —CH₂— in the C₁₋₁₂ linear alkyl or C₃₋₁₂ branched alkyl can each be independently replaced by —CH═CH—, —C≡C—, —O—, —CO—, —CO—O— or —O—CO—;
ring 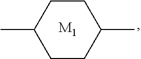
ring 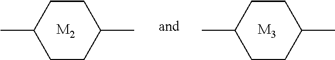
each independently represents 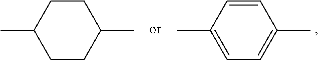
wherein, one or at least two —CH₂— in 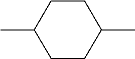
can be replaced by —O—, one or at least two single bond in the rings can be replaced by double bond; at most one —H on 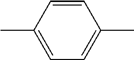
can be replaced by halogen atom;
Z_{M1} and Z_{M2} each independently represents single bond, —CO—O—, —O—CO—, —CH₂O—, —OCH₂—, —C≡C—, —CH═CH—, —CH₂CH₂— or —(CH₂)₄—; and
n_{M} represents 0, 1 or 2, wherein, when n_{M} represents 2, ring 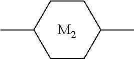
can be the same or different, Z_{M2} can be the same or different.

7. The liquid crystal composition according to claim 6, wherein the compound of general formula M is any one or the combination of at least two of the compounds with the following structures: 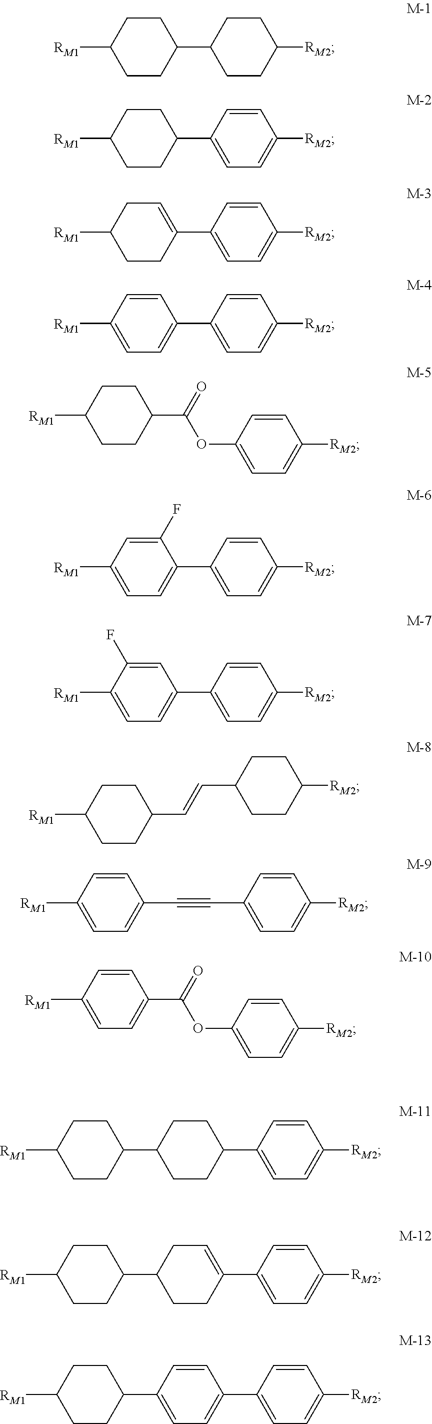 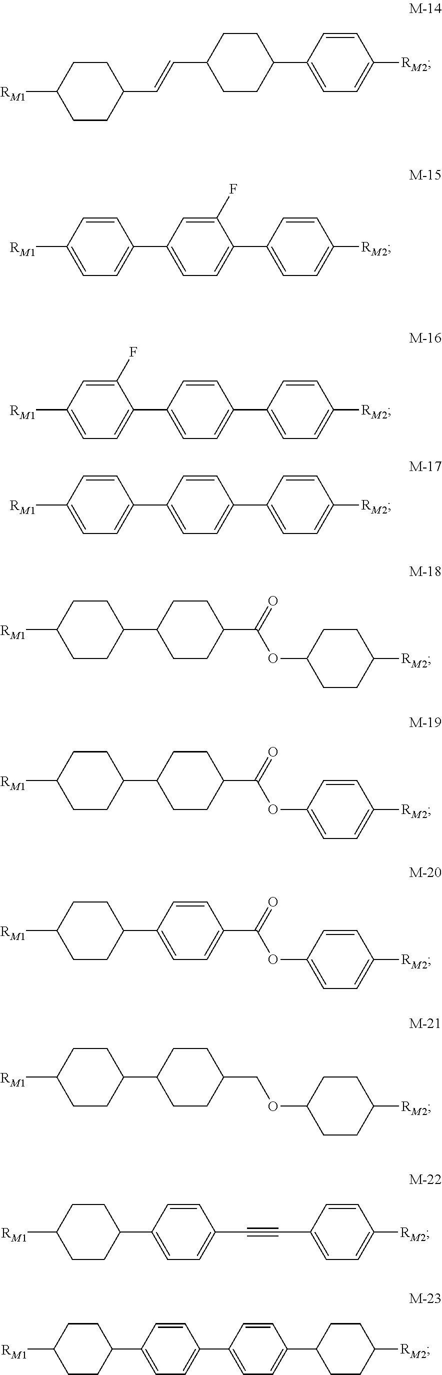 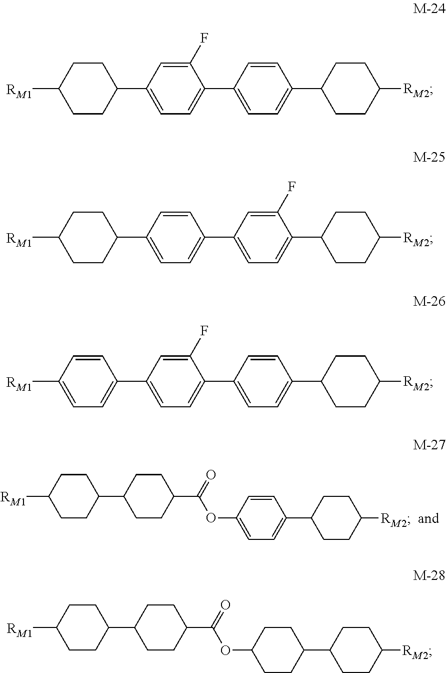
preferably, in the liquid crystal composition, percentage by weight of the compound of general formula M is 0.1%-60%.

8. The liquid crystal composition according to claim 2, wherein the liquid crystal composition comprises at least two of the compound with the general formula I-1 and the compound of general formula I-9.

9. The liquid crystal composition according to claim 3, wherein the compound of general formula II comprises at least one compound selected from a group consisting of the compound of general formula II-1 and general formula II-3 and at least one compound selected from a group consisting of the compound of general formula II-2 and general formula II-4.

10. A liquid crystal display device, wherein the liquid crystal display device comprises the liquid crystal composition of claim 1.

11. The liquid crystal composition according to claim 2, wherein:
ring 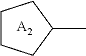
represents 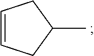
L₁ and L₂ both represent fluorine atom;
the compound of general formula I is the compound of general formula I-1 or the compound of general formula I-9; and
in the liquid crystal composition, percentage by weight of the compound of general formula I is 0.1%~35%.

12. The liquid crystal composition according to claim 11, wherein in the liquid crystal composition, percentage by weight of the compound of general formula I is 2%~25%.

13. The liquid crystal composition according to claim 3, wherein the compound of general formula II comprises the compound of general formula II-2 and/or the compound of general formula II-4.

14. The liquid crystal composition according to claim 3, wherein the liquid crystal composition comprises at least two compounds of general formula II.

15. The liquid crystal composition according to claim 3, wherein, in the liquid crystal composition, the percentage by weight of the compound of general formula II is 8%~60%.

16. The liquid crystal composition according to claim 5, wherein the compound of general formula N is any one or the combination of at least two of the compounds with the following structures:

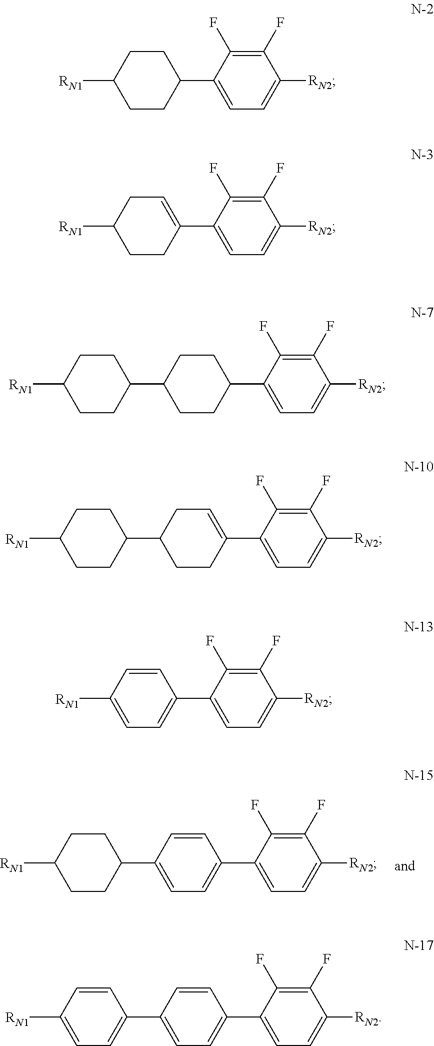

17. The liquid crystal composition according to claim 5, wherein, in the liquid crystal composition, the percentage by weight of the compound of general formula Nis 2%~45%.

18. The liquid crystal composition according to claim 7, wherein the compound of general formula M is any one or the combination of at least two of the compounds with the following structures:

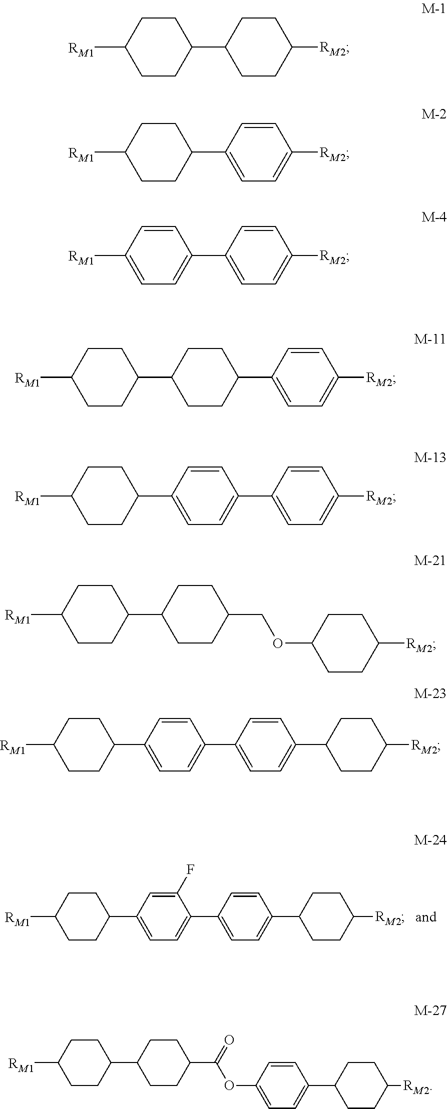

19. The liquid crystal composition according to claim 7, wherein, in the liquid crystal composition, the percentage by weight of the compound of general formula Mis 30%-50%.

20. The liquid crystal composition according to claim 2, wherein the liquid crystal composition comprises at least two of the compound with the general formula I-1 or the compound of general formula I-9.
